(19) United States
(12) Patent Application Publication
(10) Pub. No.: US 2026/0252896 A1
(43) Pub. Date: Aug. 27, 2026

(54) VIEW TRANSITION THROUGH NEURAL IMPLICIT MORPHING

(71) Applicant: DOLBY LABORATORIES LICENSING CORPORATION, San Francisco, CA (US)

(72) Inventors: Tung-I CHEN, Amherst, MA (US); Janos HORVATH, Santa Clara, CA (US); Dae Yeol LEE, San Jose, CA (US); Tsung-Wei HUANG, Fremont, CA (US); Guan-Ming SU, Fremont, CA (US)

(73) Assignee: DOLBY LABORATORIES LICENSING CORPORATION, San Francisco, CA (US)

(21) Appl. No.: 19/548,841

(22) Filed: Feb. 24, 2026

Related U.S. Application Data
(60) Provisional application No. 63/763,116, filed on Feb. 25, 2025.

(30) Foreign Application Priority Data
May 28, 2025 (EP) 25179373.3

(51) Int. Cl. G06N 3/09; G06V 10/74; G06V 10/82

(52) U.S. Cl. CPC G06N 3/09; G06V 10/761; G06V 10/82

(57) ABSTRACT

Matching keypoint pairs are generated and identified in original and rectified image spaces between two input images. A teacher neural network is trained based at least in part on the pairs of matching keypoints in the rectified image space. A neural implicit morphing network is trained jointly with the teacher neural network based at least in part on the matching keypoint pairs in the original image spaces in which predictions outputted from the teacher neural network are used to compute a loss function designated to train the neural implicit morphing network. The neural implicit morphing network on its own, after training, is caused to output intermediate images in the view transition between the two input images.

### CROSS-REFERENCE TO RELATED APPLICATIONS

This application claims the benefit of priority from U.S. Provisional Patent Application No. 63/763,116, filed on 25 Feb. 2025 and European Patent Application No. 25179373.3, filed on May 28, 2025. The contents of all of the above applications are incorporated by reference in their entirety for all purposes.

### TECHNOLOGY

The present disclosure relates generally to visual computing and more particularly to view transition through neural implicit morphing.

### BACKGROUND OF THE INVENTION

Generating view transitions that create smooth transitions between different views is an important task in computer graphics and may be essential for applications such as telepresence and virtual walkthroughs in mixed reality environments. Seamless transitions from one view to another can be used to provide visually coherent and engaging contents and enhance the overall user media consumption experience.

Some view transition methods rely on leveraging three-dimensional (3D) information to reconstruct 3D models of visual scenes either explicitly or implicitly and then rendering these models from various viewpoints. However, these methods typically require dense sampling of observations and are computationally expensive in terms of both content creation and rendering. Additionally, compressing and delivering 3D scene representations efficiently remains a challenge, as they may not be compatible with current or available content delivery standards.

Some other view transition methods may rely on image-based rendering (IBR) that synthesizes virtual views directly from input images, bypassing explicit 3D reconstruction. Multi-plane image (MPI) is one such example that renders a set of planes to produce realistic intermediate views efficiently. Non-learning-based IBR or MPI methods offer some advantages such as comparatively low computational cost and ability to generate new views with limited input data. However, these methods face significant challenges including depth estimation uncertainties, occlusion problems with which parts of a visual scene may be hidden in some images but visible in some others. In comparison, deep learning-based IBR or MPI methods may incur computational expenses that hinder real-time applications.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present disclosure is illustrated by way of example, and not by way of limitation, in the figures of the accompanying drawings and in which like reference numerals refer to similar elements and in which:

FIG. 1A illustrates an example view transition training and inference pipeline; FIG. 1B illustrates an example data preprocessing stage; FIG. 1C illustrates an example pre-training stage; FIG. 1D illustrates an example joint training stage; FIG. 1E illustrates an example inference stage;

FIG. 2A illustrates example images in original and rectified image spaces; FIG. 2B illustrates example homography warping; FIG. 2C illustrates example image morphing between two viewpoints; FIG. 2D illustrates example visual distortions that may be introduced in view morphing operations; FIG. 2E illustrates an example view transition;

FIG. 3A illustrates example operational scenario relating to an image morphing or view transition pipeline; FIG. 3B and FIG. 3C illustrate example operational scenarios in which neural network based morphing models can be trained in advance to generate optimized operational parameter passed as metadata to a recipient device to perform inference in connection with view transitions;

FIG. 4 illustrates an example process flow; and

FIG. 5 illustrates an example hardware platform on which a computer or a computing device as described herein may be implemented.

### DETAILED DESCRIPTION OF THE INVENTION

Example embodiments, which relate to view transition through neural implicit morphing, are described herein. In the following description, for the purposes of explanation, numerous specific details are set forth in order to provide a thorough understanding of the present disclosure. It will be apparent, however, that the present disclosure may be practiced without these specific details. In other instances, well-known structures and devices are not described in exhaustive detail, in order to avoid unnecessarily occluding, obscuring, or obfuscating the present disclosure.

Example embodiments are described herein according to the following outline:
1. GENERAL OVERVIEW
2. VIEW MORPHING AND INTERPOLATION
3. TRAINING AND INFERENCING PIPELINE
4. COORDINATE-BASED NEURAL NETWORKS
5. AUXILIARY AND MAIN NEURAL NETWORKS
6. LOSS FUNCTIONS
7. MAIN NEURAL NETWORK INFERENCING
8. EXAMPLE TRAINING PROCEDURES
9. EXAMPLE PROCESS FLOWS
10. IMPLEMENTATION MECHANISMS—HARDWARE OVERVIEW
11. EQUIVALENTS, EXTENSIONS, ALTERNATIVES AND MISCELLANEOUS

### 1. General Overview

This overview presents a basic description of some aspects of an example embodiment of the present invention. It should be noted that this overview is not an extensive or exhaustive summary of aspects of the example embodiment. Moreover, it should be noted that this overview is not intended to be understood as identifying any particularly significant aspects or elements of the example embodiment, nor as delineating any scope of the example embodiment in particular, nor the disclosure in general. This overview merely presents some concepts that relate to the example embodiment in a condensed and simplified format, and should be understood as merely a conceptual prelude to a more detailed description of example embodiments that follows below.

Techniques as described herein can be implemented to produce a view transition by generating relatively smooth physically valid intermediate view images between two given input images with two endpoint views, referred to as source and target images. The techniques can create visually pleasing view transitions and ensure intermediate view images to be created or generated between the two endpoint views in real-time with relatively low time latencies. These techniques can be used to support a wide variety of video/image related applications including but not necessarily limited to only latency-critical applications.

As used herein, “physically valid” or “perceptually valid” or “natural” may mean that intermediate images in a view transition between or demarcated by two endpoint views captured by two cameras at two specific (e.g., non-planar, etc.) viewpoints are generated through image warping or image morphing operations with a smooth camera-moving-like effect as if these intermediate images are generated or captured with cameras. As visually perceived by a viewer/user, an intermediate image in a physically valid view transition as described herein depicts image details such as characters, visual objects of different inherent spatial shapes, etc., in a way as if the intermediate image was captured by a—e.g., moving or still—camera with a (e.g., single, etc.) camera or lens specific viewpoint for the intermediate image.

Conversely, “physically invalid” or “perceptually invalid” or “unnatural” may mean that some or all intermediate images in a view transition does not appear as if captured by any (e.g., moving, still, etc.) camera with a (e.g., single, etc.) camera or lens specific viewpoint. An intermediate image in a physically invalid transition may look like a mixture of image details from multiple cameras with multiple different viewpoints (e.g., different non-coplanar image planes, different non-parallel optical axes, etc.) or may resemble a surrealist image in which physical relationships relating to inherent spatial shapes or spatial/geometric relationships of some or all depicted objects are rendered invalid or inapplicable. Example physically invalid images may include, but are not necessarily limited to only, images containing wiggly visual artifacts, ghosting artifacts, duplicates or sudden—non-smooth physical or virtual camera movement—transition, etc.

A viewpoint such as a camera or lens specific viewpoint may refer to a specific spatial position and/or a specific spatial direction in a three-dimensional (3D) space of a physical, rendered, virtual, imaginary, virtually moved or transitioned camera to capture or generate an image of a visual scene in the 3D space.

Image warping or morphing operations used to generate a view transition may refer to any, some or all of: neural network based or neural implicit image warping or morphing operations under techniques as described herein, non-neural network based image warping or morphing operations, neural network based image warping or morphing under other approaches that do not implement some or all techniques as described herein, etc.

In some operational scenarios, the two endpoint views of the view transition as described herein may be captured by a stereoscopic camera comprising two camera elements with two different (left-view and right-view) viewpoints. Additionally, optionally or alternatively, the two endpoint views may be selected from a multi-view image—comprising multiple images of different views—captured by a multi-view camera comprising multiple camera elements with multiple different viewpoints, for example to support immersive, panoramic, 360-degree, interactive, augmented reality or AR, mixed reality or MR, virtual reality or VR, telepresence, computer game related, etc., video/image display applications.

Two cameras with two different viewpoints may have two different image planes that may or may not coplanar. These cameras may or may not be located at the same distance from a physical or virtual scene depicted by the endpoint or intermediate images in the view transition. The cameras may acquire, capture or are used to generate endpoint images as described herein with the same or different camera settings. The endpoint images captured or generated with different cameras may depict the same 3D visual scene in a 3D space with two-dimensional (2D) image/pixel data in different original image spaces associated with the different cameras.

An original image space associated with a camera—or in which corresponding images captured by the camera are represented—may be defined or specified based at least in part on the camera's image plane and/or an optical axis of the camera physical/virtual lens used to capture or generated image/pixel data in an image.

Under some approaches that do not implement techniques as described herein, image warping is implemented with adjusting pixel positions based on estimated depth and camera parameters—suffer from depth estimation uncertainties and occlusions, resulting in (e.g., visible or perceptible, image texture, etc.) holes and disparity/inconsistency between left and right (view) warped images. While image morphing may be used to blend pixel values and shapes depicted in images or videos to create intermediate video/image frames, the resulting intermediate video/image frames may contain serious visual artifacts and depict motions of pixels/objects visually perceived by viewers as not physically valid.

To overcome challenges faced by these and other approaches, techniques as described herein integrate neural implicit morphing with image rectification. Coordinate-based neural networks may be used to parameterize transformations from one image space to another without implicit or explicit 3D scene reconstruction. In addition, a novel joint training strategy may be implemented to regularize motion paths of pixels in intermediate images during view transition. An auxiliary morphing network or a teaching artificial neural network may be pre-trained in a rectified image space.

As used herein, a rectified image space may refer to an image space into which images of different views (e.g., two or more views, etc.) are spatially transformed such that the spatially transformed images represented in the rectified image space satisfy a monotonicity constraint under which some or all relative positions of different image features depicted in the transformed images are (e.g., largely, entirely, etc.) maintained the same visually perceptible order. For example, corresponding scene points in the spatially transformed images appear in the same order in these images represented in the rectified image space. The satisfaction of this constraint by the spatially transformed images of different views allows the auxiliary or teacher network to learn a smooth and visually reasonable—or physically valid as visually perceived by viewers—view transition between or among these spatially transformed images of different views.

Subsequent to or in parallel with the training of the auxiliary (or teacher/tutor) neural network, coordinates of pixels in predicted or output images generated from the auxiliary neural network and represented in the rectified image space can be inversely spatially transformed or projected back—using homography transformations or transformation matrixes—to their respective original image spaces and used to supervise the training of a main (neural implicit) morphing network, the latter of which may be a relatively light-weighted artificial neural network. This main morphing network after training may be used, for example by an end user device, to produce or predict a photorealistic or physically valid view transition between or among different views in the original image space(s) without relying on or using implicit or explicit depth or camera pose estimation.

In contrast with other deep learning-based view transition methods that rely on heavy network architectures and computationally intensive inference, an artificial intelligence (AI) or machine learning (ML) model under techniques as described herein employs a relatively simple (e.g., two-hidden-layer multi-layer perceptron or MLP, etc.) neural implicit morphing network capable of real-time inference to support view transition with relatively low time latency and relatively small computational resource usage, making these methods suitable for interactive end-user applications, among many other benefits.

Example embodiments described herein relate to generating intermediate images in view transitions. Pairs of matching keypoints in original image spaces are generated based at least in part on image feature correspondences established between two input images of two endpoint views for a view transition. Pairs of corresponding matching keypoints in a rectified image space are identified based at least in part on homography transformation matrices derived from the pairs of matching keypoints in the original image spaces. Each pair in the pairs of corresponding matching keypoints in the rectified image space correspond to a respective pair in the pairs of matching keypoints in the original image spaces. A teacher neural network is trained based at least in part on the pairs of corresponding matching keypoints in the rectified image space. A neural implicit morphing network is trained jointly with the teacher neural network based at least in part on the pairs of matching keypoints in the original image spaces in which predictions outputted from the teacher neural network are used to compute a loss function designated to train the neural implicit morphing network. The neural implicit morphing network on its own, after training jointly with the teacher neural network, is caused to output intermediate images in the view transition between the two endpoint views represented in the two input images.

In some example embodiments, mechanisms as described herein form a part of a media processing system, including but not limited to any of: an image processing system, a video or image encoder, a video or image decoder, a media content provider system, a media content streaming system, a mobile device, a wearable device, a computer server, a media processing system, a cloud based computing system, laptop computer, netbook computer, tablet computer, desktop computer, computer workstation, or various other kinds of computing devices and media processing units.

Various modifications to the embodiments and the generic principles and features described herein will be readily apparent to those skilled in the art. Thus, the disclosure is not intended to be limited to the embodiments shown, but is to be accorded the widest scope consistent with the principles and features described herein.

### 2. View Morphing and Interpolation

Image-Based Rendering (IBR) techniques may focus on synthesizing novel views of a scene directly from a set of input images without explicitly reconstructing the scene's geometry. For example, IBRNet—examples of which are described in Wang, Qianqian, et al., “Ibrnet: Learning multi-view image-based rendering,” Proceedings of the IEEE/CVF conference on computer vision and pattern recognition (2021), the contents of which are incorporated herein by reference in entirety—employs a neural network to learn or train a multi-view image-based rendering model that can be used to synthesize novel views by fusing information from multiple input images. Using feature aggregation, the IBRNet may handle varying scene complexities and lighting conditions as well as occlusions and complex scene details.

DynIBaR—examples of which are described in Li, Zhengqi, et al., “Dynibar: Neural dynamic image-based rendering,” Proceedings of the IEEE/CVF Conference on Computer Vision and Pattern Recognition (2023), the contents of which are incorporated herein by reference in entirety—further integrates temporal information to render dynamic scenes with moving objects and changing lighting, leveraging a temporal fusion network to combine information across time and enable synthesizing temporally coherent and visually consistent novel views. However, these deep learning-based IBR methods have limitations. Their inference times remain a significant bottleneck. In addition, these techniques consume substantial computational resources and are not yet capable of real-time rendering.

View morphing and interpolation methods rely on geometric and/or photometric transformations to create smooth transitions between images of different views. Example view morphing methods may include those implemented with mesh warping, feature-based methods, cross-dissolve techniques, etc., and focus on manipulating image geometry and color blending to achieve seamless morphs between images. Geometric proxies and linear interpolation may be used to generate novel views from two input images of different views. Disparity between the images may be calculated. Intermediate views may be interpolated by warping the images based at least in part on the disparity. Accordingly, physically accurate intermediate views may be generated to help ensure the interpolated images/views to adhere to geometric and photometric constraints of the depicted scene, resulting in relatively realistic renderings. In addition, interpolation may be implemented both spatially between different views of the same timepoint and temporally across images/views at different timepoints (or timestamps), for example in image sequences, enabling relatively smooth transitions in both space and time.

Deep neural networks (DNNs) may be used to improve capabilities of view morphing and interpolation. These DNNs may be used to learn complex mappings between views, achieving relatively high fidelity and robust performance in diverse scenarios. Example DNNs are described in Feng, Brandon Yushan et al., “Viinter: View interpolation with implicit neural representations of images,” SIGGRAPH Asia 2022 Conference Papers (2022), the contents of which are incorporated herein by reference in entirety. Implicit neural representations may be used in a DNN-based model to learn underlying scene structure and appearance, enabling relatively high-quality view interpolation from sparse input views, learning continuous and differentiable scene representations, generating relatively smooth and realistic intermediate views with detail and accuracy, and handling complex scenes with intricate details and lighting variations. However, under other approaches, a DNN-based model comes with significant limitations in that inference times of the DNN-based model may typically be high and view transitions involving relatively high-dimensional features may not be interpreted correctly by a decoder. As a result, these other approaches may not be practical in real-time systems and/or applications.

Coordinate-based (artificial) neural networks may be used to represent continuous signals including but not limited to images. Examples of coordinate-based networks may include, but are not necessarily limited to only, sinusoidal representation network (SIREN), which uses sine functions as activation functions in a multilayer perceptron (MLP) and is capable of capturing relatively fine details and relatively high (spatial and/or temporal) frequency components in input signals or images. Example coordinate-based or SIREN networks are described in Sitzmann, Vincent, et al., “Implicit neural representations with periodic activation functions”; and Tancik, Matthew, et al., “Fourier features let networks learn high frequency functions in low dimensional domains,” Advances in neural information processing systems 33 (2020): pp 7537-7547 and 7462-7473, the contents of both of which are incorporated herein by reference in entirety.

Techniques as described herein can be implemented to use coordinate networks for image morphing. These coordinate networks—which may be implemented with trained MLPs parametrizing (e.g., implicit) image morphing functions—can be used to represent continuous transformation of pixel coordinates relatively smoothly among different views including both source and target views and intermediate views. These coordinate networks or MLPs can learn relatively complex mappings from one set of image coordinates to another. The use of SIRENs in these networks or MLPs supports relatively accurate modeling of periodic nature of image content, thereby achieving relatively smooth transitions between different images/views.

These networks such as SIRENs can be readily and efficiently optimized using gradient descents, making them well-suited for tasks involving fine-tuned transformations such as view morphing and interpolation. An auxiliary or teacher morphing network may be pre-trained in a rectified domain (or a rectified image space) in which geometric relationships between (image or visual) feature or keypoints are simplified and regulated. The auxiliary or teacher/tutor network can be used to train and improve a main network that operates on or performs view morphing in original image space(s). This overall joint training strategy enhances physical validity of generated view transitions, ensuring resultant intermediate images/views to be both visually pleasing and geometrically or physically consistent as perceived by viewers.

Hence, coordinate networks or MLPs under techniques as described herein can be used to provide a relatively flexible and powerful framework for image morphing as well as enable creating relatively smooth and realistic view transitions with a minimal or minimized computational resource and usage overhead.

### 3. Training and Inferencing Pipeline

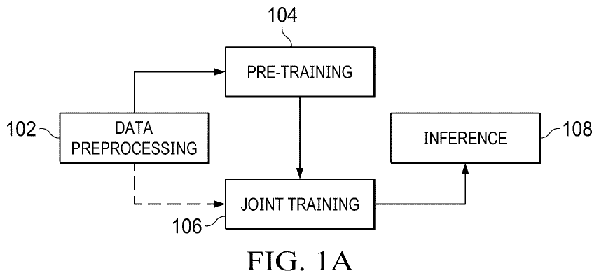

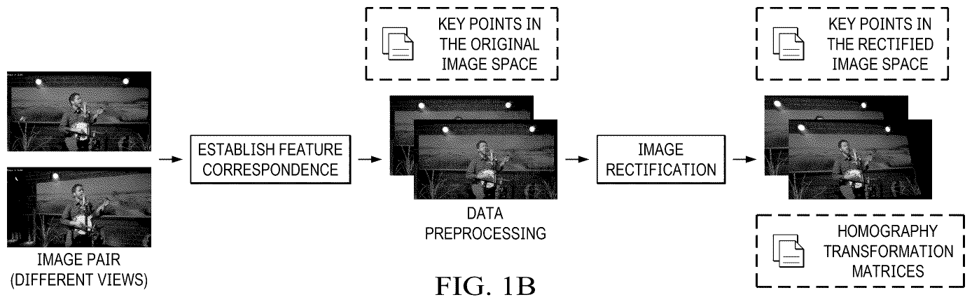

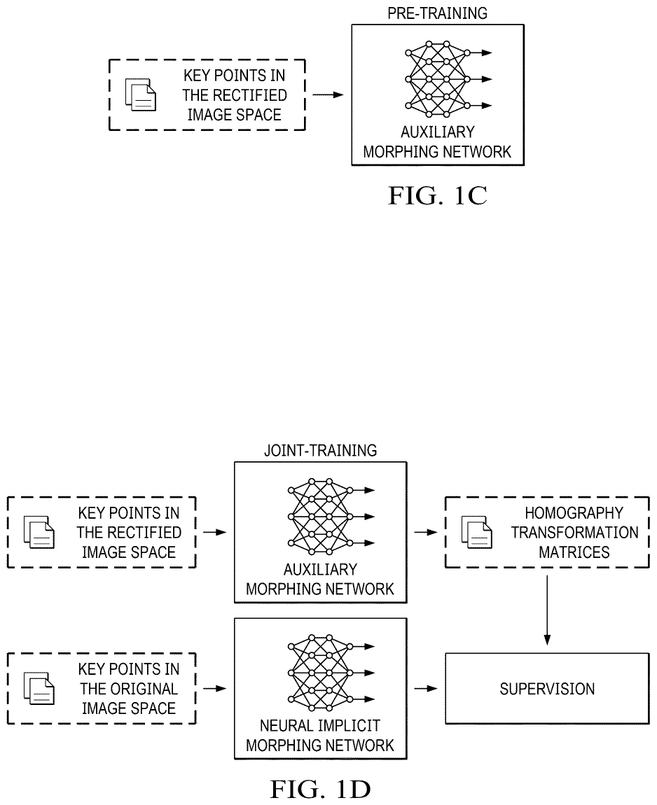

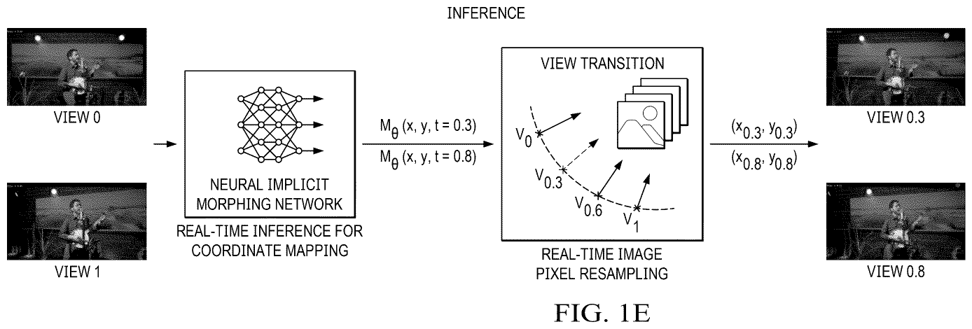

FIG. 1A illustrates an example view transition training and inference pipeline using a neural implicit morphing (NIM) network. The pipeline includes a data preprocessing stage 102, a pre-training stage 104, a joint training stage 106 and an inference stage 108. It should be noted that some components or operations in the pipeline such as keypoint detection, image rectification processing, and an auxiliary (or teacher/tutor) morphing network may be used or implemented in an overall training stage that includes the data preprocessing stage, the pre-training stage and the joint training stage. The inference stage may operate (e.g., entirely, etc.) with a light-weight main network—such as an MLP composed of (e.g., only, etc.) two hidden layers—to generate a view transition with an end user device. Hence, the pipeline allows end (user) devices to perform relatively data-efficient and low time latency real-time view transitions. Example neural implicit morphing (NIM) operations are described in Schardong, Guilherme, et al., “Neural implicit morphing of face images,” Proceedings of the IEEE/CVF Conference on Computer Vision and Pattern Recognition (2024), the contents of which are incorporated herein by reference in entirety.

FIG. 1B illustrates an example data preprocessing stage in the view transition training and inference pipeline. In the data preprocessing stage, a pair of source and target images with different views may serve as input to operations relating to keypoint extraction in (e.g., non-co-planar, etc.) original image spaces, feature correspondence establishment based at least in part on extracted keypoints, homography transformation (matrices) used to transform the source and target images and the extracted keypoints into a rectified image space (or co-planar image spaces, etc.).

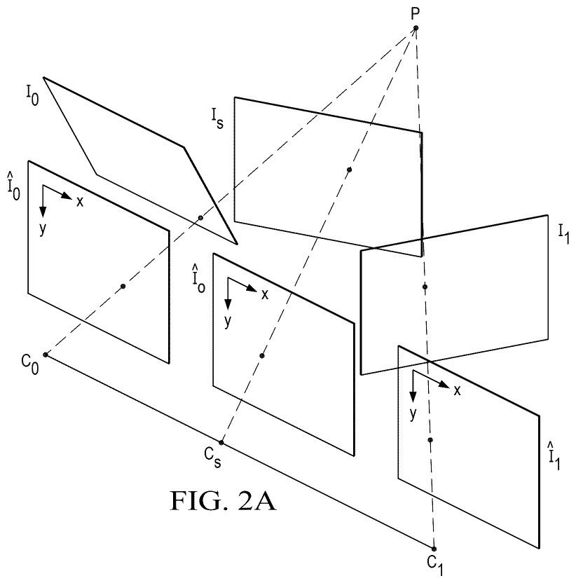

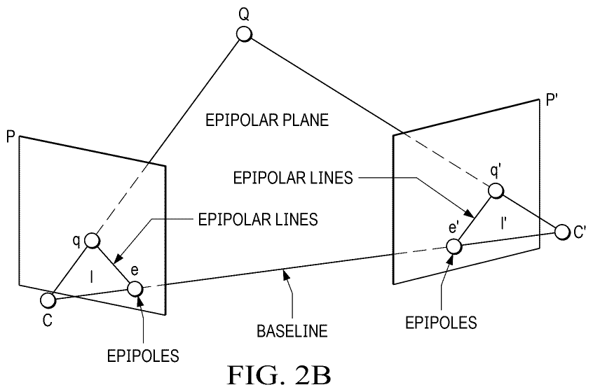

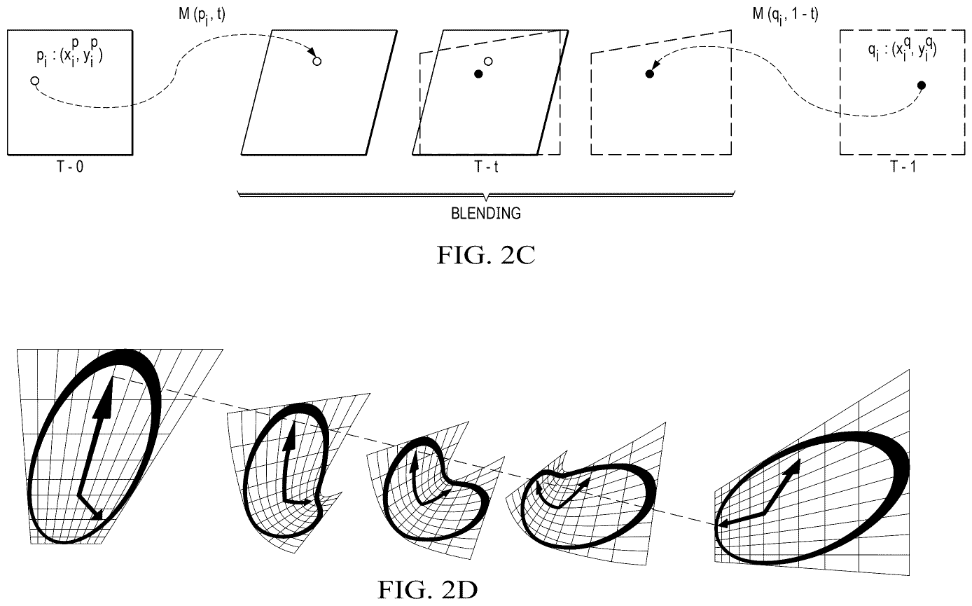

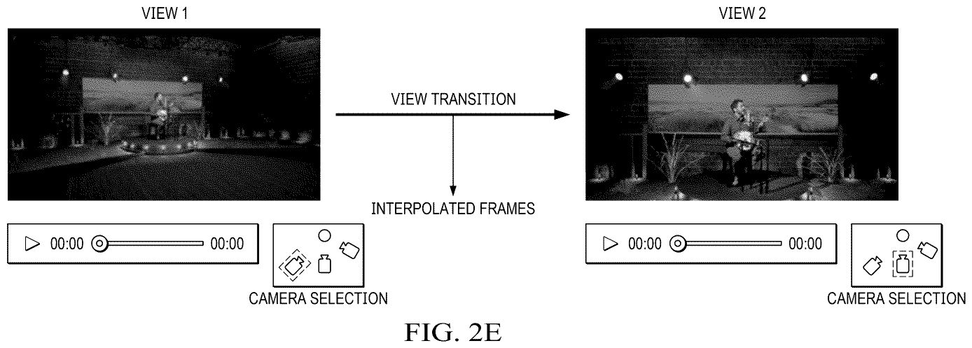

Let I₀ and I₁: [symbol] ²→(r, g, b) denote the source and target images, respectively, as illustrated in FIG. 2A. These two images I₀ and I₁ may be used to represent the two (endpoint) views of a view transition.

Let I(x, y) denote a pixel value of an image I—which may be one of I₀ and I₁ or an intermediate image (denoted as I_{S} in FIG. 2A) of an intermediate view in the view transition—at an image coordinate or pixel location (x, y). Image coordinates or pixel locations in a given image may be represented in an original image space associated with the given image. This original image space may be characterized in part or in whole by a combination of (1) an optical axis of a camera lens used to capture logically or physically the given image of a visual scene in a three-dimensional (3D) space; and (2) a specific reference position—such as the upper left corner of the image I—at an image plane on which image pixels or pixel locations are arranged.

In some operational scenarios, image feature correspondences between the source and target images I₀ and I₁ may be established based at least in part on keypoints extracted from the source and target images represented in their respective original image spaces, for example using a Local Feature Transformer (LoFTR) method, which is described in Sun, Jiaming et al., “LoFTR: Detector-free local feature matching with transformers,” Proceedings of the IEEE/CVF conference on computer vision and pattern recognition (2021), the contents of which are incorporated herein by reference in entirety.

The LoFTR method may be used, implemented or enhanced to detect a set or plurality of landmarks/keypoints {pᵢ, qⱼ}ⁿ between a pair of images such as the source and target image I₀ and I₁ represented in their respective original image spaces. These landmarks/keypoints may be used as bases to train or optimize AI/ML models (e.g., operating in the original and/or rectified image spaces, etc.) implementing a neural morphing function.

In some operational scenarios, the LoFTR method employs or uses a transformer-based architecture to first extract relatively dense and accurate correspondences between the source and target images I₀ and I₁ represented in their respective original image spaces, even in operational scenarios in which there are significant appearance changes, occlusions, and varying lighting conditions in these images. Moreover, the LoFTR method can be used or implemented to perform further end-to-end feature matching without relying on handcrafted keypoint detectors and descriptors.

More specifically, a convolutional neural network (CNN) backbone may be used in the LoFTR method to extract initial features from the source and target images I₀ and I₁ represented in their respective original image spaces, followed by a transformer module that refines the extracted initial features to capture relatively long (e.g., spatial, temporal, over a relatively large pixel locational range, over a relatively long time interval, etc.) range dependencies between the source and target images. The transformer module may include or implement a self-attention mechanism capable of identifying and correlating the extracted/captured/refined features across entire images in the source and target images, leading to relatively accurate and robust keypoint matches.

Hence, in the data pre-processing stage, the LoFTR method can operate with attention mechanisms/models/transformers to perform pre-processing on the (input) source and target images in their original image spaces to detect or generate (image) feature correspondences between the landmarks/keypoints. These feature correspondences may be relatively accurately and efficiently determined, specified, or represented as pairs of landmarks/keypoints using pixel coordinates or locations of these landmarks/keypoints represented in their respective original image spaces. These keypoints and/or the feature correspondences provide a solid foundation for training neural morphing or warping functions in the AI/ML models in the subsequent stages of the same view transition processing pipeline.

The integration of the LoFTR method with the pipeline or the data pre-processing stage therein can help the overall view transition processing pipeline to handle or process relatively complex scenes depicted in videos/images and achieve relatively high quality image morphing in the resultant view transition.

By way of illustration but not limitation, a plurality of (e.g., n, etc.) pairs of landmarks/keypoints denoted as {pⱼ, qⱼ}ⁿ—corresponding to white solid dots in FIG. 1B—in the source and target images represented in their respective original image spaces may be determined, where j represents an index to the landmarks. These landmarks/keypoints {pⱼ, qⱼ}ⁿmay be used (e.g., as anchors, as fiduciary marks, as keypoints, etc.) in (e.g., non-neural network based, neural implicit, etc.) image morphing or warping,

Each pair p, q∈ [symbol] ² in {pⱼ, qⱼ}ⁿ represents two sets of 2D coordinates for a respective landmark/keypoint depicted in the original image spaces of the source and target images, respectively. The pair of sets of the 2D coordinates of the respective landmark/keypoint in the source and target images or their original image spaces may be sampled from spatial (pixel) domains—corresponding to respective image planes of physical or logical cameras used to capture the source and target images—of the source and target images I₀ and I₁ as having a (mutual) feature correspondence such as (mutually) corresponding to the same specific point (e.g., P of FIG. 2A, etc.) in a user-perceptible (semantic) image feature such as an eye, a nose, chin, an object, a shape, etc. present or depicted in both of the source and target images. The pair of sets of 2D coordinates (e.g., black dots in the images of FIG. 2A) of the respective landmark/keypoint in the source and target images I₀ and I₁ may or may not have the same coordinate or pixel location, the same pixel values, etc., in their respective images, as their respective original image spaces are different from each other (e.g., in terms of optical axes perpendicular to their image planes or specific reference positions on the image planes, etc.) and often non-planar, as illustrated in FIG. 2A.

The image feature correspondences or pairs of sets of 2D coordinates representing pairs of corresponding landmarks/keypoints in the source and target images I₀ and I₁ represented in the original image spaces can be used to compute homograph transformations to warp, rectify or transform one or both of the source and target images into rectified source and target images (denoted as [symbol] and [symbol] in FIG. 2A; with parallel views or parallel image planes) a rectified image space in which respective image features, landmarks/keypoints (e.g., corresponding to a specific visual scene point P of FIG. 2A, etc.) thereof, represented in the rectified source and target images [symbol] and [symbol] can be mapped or aligned relatively accurately in the rectified image space.

Homography transformations (or transformation matrixes) may be generated by solving spatial transformation equations satisfying multiple (e.g., geometry, smoothness, mapping, etc.) constraints derived from or formulated with some or all the pairs of landmarks. These homography transformations may be constrained to map each set of 2D coordinates (in the source original image space) in a pair of sets of 2D coordinates for a landmark/keypoint to the other set of 2D coordinates (in the target original image space) in the same pair of sets of 2D coordinates for the same landmark/keypoint.

FIG. 2B illustrates example homography warping. The two rectangles in FIG. 2B represent two image planes of two different views denoted as P and P′, respectively. A common landmark/keypoint Q in 3D space is projected onto the respective image planes at points q and q′. The camera origins for the two views are labeled C and C′, while the line connecting these origins is referred to as the baseline. The points where the baseline intersects each image plane may be referred to as epipoles, denoted as e for view P and e′ for view P′.

A homography transformation and/or corresponding warping matrices for each view may be generated and used to enable a global (not local) transformation that aligns the two views' epipolar lines linearly.

By way of illustration but not limitation, a transform matrix used to convert q to q′ may be referred to as an essential matrix denoted E. This transformation matrix E may be related to intrinsic camera parameters as follows:

$${{q}^{′ T} ( {K}^{l} )}^{- T} E {K}^{- I} q = 0 \qquad ( 1 )$$

where K and K′ denote intrinsic camera parameters for views P and P′, respectively. Oftentimes, these camera parameters may be unknown. For simplicity, K and K′ may be combined with the transformation matrix E together as a single matrix to be predicted or estimated, as follows:

$${q}^{′ T} Fq = 0 with F = {( {K}^{′} )}^{- T} {EK}^{- 1} \qquad ( 2 )$$

where the single matrix F may be referred to as a fundamental matrix. The fundamental matrix may be a rank 2 singular matrix with seven (7) degrees of freedom or matrix elements, the values of which may be fully determined based on 8-point pairs to derive the matrix values of the fundamental matrix F. In other words, eight (8) pairs of corresponding landmarks or keypoints from the two views P and P′ may be used to solve for the fundamental matrix or the values of the matrix elements therein, as follows:

$${min}_{F} {‖ {q}^{′ T} Fq ‖}^{2} s . t . {‖ F ‖}^{2} = 1 \qquad ( 3 )$$

The epipoles e and e′ may be derived from F by applying Singular Value Decomposition (SVD) on F, as follows:

$$F = U \sum {V}^{T} \qquad ( 4 )$$

where e (or a set of coordinate values of e) may be derived as or from the last column of V and e′ (or a set of coordinate values of e′) may be derived as or from the last column of U.

The epipoles e and e′ can be used to derive a rectifying homography matrix for each view P or P′ as follows. For the purpose of illustration only, a homography matrix H for P (left view) may be derived. It should be understood that a homography matrix H′ for P′ (right view) may be likewise derived.

Given the epipole e with coordinates or coordinate values of (eₓ, e_{y}, e_{z}), a rotation angle or amount θ for rectification can be derived as

$$θ = arctan ( \frac{{e}_{y}}{{e}_{x}} ) .$$

A corresponding rotation matrix denoted as R may be given as follows:

$$R = [ \begin{matrix}cos θ & - sin θ & 0 \\ sin θ & cos θ & 0 \\ 0 & 0 & 0\end{matrix} ] \qquad ( 5 )$$

Let (cₓ, c_{y}) denote the center coordinates or coordinate values of the image or view P. A corresponding translation matrix denoted as T to center-align the image or view P may be obtained as follows:

$$T = [ \begin{matrix}1 & 0 & - {c}_{x} \\ 0 & 1 & - {c}_{y} \\ 0 & 0 & 0\end{matrix} ] \qquad ( 6 )$$

A corresponding scaling factor may be used to ensure the rotated epipole has a unit (or correctly scaled) x-coordinate. A corresponding scale or scaling matrix denoted as S may be obtained as follows:

$$S = [ \begin{matrix}s & 0 & 0 \\ 0 & s & 0 \\ 0 & 0 & 0\end{matrix} ] \qquad ( 7 )$$

where

$$S = \frac{1}{{( RTe )}_{x}} .$$

Here (RTe)ₓ refers to the x-component of the rotated epipole.

The (final) rectifying homography matrix—which may also be referred to as a homography warping matrix—H for view P can be obtained as follows:

$$H = SRT \qquad ( 8 )$$

This matrix can be applied globally to the view P and warps view P into a rectified image space. As noted, the homography matrix H′ for view P′ may be derived in a similar procedure described above.

Using these homography transformations (or transformation matrixes) and/or their inverse transformations (or inverse transformation matrixes), the landmarks/keypoints in an image of the visual scene represented in one image space can be forward or inversely mapped to the same landmarks or keypoint in another image of the visual scene represented in another image space. Example image spaces—between which homography transformation(s) (or transformation matrix(es)) as described herein may be used to map—may include, but are not necessarily limited to only, any, some or all of: the original source image space, the original target image space, an intermediate image space in which an intermediate image such as I_{S} is represented, the rectified image space in which the rectified source image [symbol] , the rectified target image [symbol] and a rectified intermediate image [symbol] corresponding to the intermediate image I_{S} are represented, etc., as illustrated in FIG. 2A

Homography transformation(s) (or transformation matrix(es)) as described herein may be applied to one (e.g., only the target image, only the source image, etc.) or both of the source and target images in image rectification operations to generate the rectified source and target images in the same rectified image space (or a set of rectified image spaces coplanar with one another). Some or all of the image rectification operations may be performed or implemented with an available OpenCV method.

The rectified source and target images in the rectified image space can be used by the AI/ML models in the pipeline to achieve or generate relatively smooth image morphing including but not limited learning motions of pixels that start from two different endpoints yet are aligned at each intermediate step or view. Detecting keypoints and landmarks and establishing image feature correspondences between the (source and target) image pair with relatively high precision and robustness of tools including but not limited to LoFTR can help ensure the subsequent neural network based morphing/warping/blending operations or processes to be based on relatively reliable and consistent feature correspondences.

### 4. Coordinate-Based Neural Networks

As noted, coordinate-based neural networks may be used in the AI/ML models—such as the auxiliary (or teacher/tutor) morphing network operating in the rectified image space and the main morphing network operating in the original image spaces—to achieve or perform image morphing. This novel image morphing approach may be refer to as neural implicit warping or simply neural warping.

The coordinate-based (or parameterized) morphing networks can be implemented as multilayer perceptrons (MHLPs), for example based on sinusoidal periodic activation functions of (hidden layer) nodes in the networks. These MLPs may be referred to as SIRENs. An MLP or SIREN as described herein can be implemented with a relatively simple neural network architecture for implicit neural coordinate mapping, using sine (periodic) functions as activation functions for neural network nodes forming the MLP or SIREN or neural network layers therein. The MLP or SIREN network may be represented as follows:

$$SIREN ( x ) = {W}_{n} ( {τ}_{n - 1} ∘ {τ}_{n - 1} ∘ … ∘ {τ}_{0} ) ( x ) \qquad ( 9 )$$

$${τ}_{i} ( {x}_{i} ) = sin ( {W}_{i} {x}_{i} + {b}_{i} ) \qquad ( 10 )$$

where τᵢ represents the i-th layer of the MLP or SIREN network; “o” denotes function composition operations between successive layers of the MLP or SIREN network. In other words, the MLP or SIREN network may be represented as a compositional function using sine activation functions of nodes in the different layers. The sine activation functions may include (in their function arguments) or operate with an affine transform defined or specified with a weight matrix denoted as Wi and biases denoted as bᵢ applied on input xᵢ, where x₀ or simply x may be 2D or 3D coordinates; followed by applying a sine (intrinsically or mathematically with nonlinearity) function applied to each component of a resulting vector from the affine transform. The (initial) x input to the MLP or SIREN network may have three dimensions including two-dimensional image (pixel) coordinates and one-dimensional morphing step t (denoting or indexing intermediate views).

Sinusoidal representation networks or SIRENs are relatively ideally suited for representing complex natural signals (e.g., videos or images or pixel values therein, etc.) and their derivatives. The suitability of coordinate-based neural networks such as sinusoidal MLPs lor SIREN for parameterizing functions used to represent continuous transformations in neural network based image morphing—or neural implicit morphing—lies in several (e.g., key, main, non-limiting example, etc.) attributes or factors.

First, an MLP or SIREN networks as described herein inherently captures the periodic nature of the sine functions, making it relatively adept or robust at modeling smooth and continuous transformations. This is particularly advantageous for (neural implicit) image morphing in which intermediate transformations for intermediate views between end point images of different views need to be gradual (or continuous) and coherent.

Second, the use of sinusoidal activation functions in the MLP or SIREN network ensures that the network can learn relatively high (spatial and/or temporal) frequency (image) details, which may be important or beneficial for maintaining image fidelity during an (neural implicit) image morphing or view transition process. This capability of learning or modeling relatively accurately the high frequency details in the images enables the network to generate or represent relatively intricate or fine spatial or image (including but not limited to photometric) transformations that may involve subtle variations in image structures (e.g., depth, occlusion, disocclusion, etc.) or textures, ensuring that the image morphing or view transition process does not produce or result in loss of user perceptible image details and/or introduction of visually perceptible artifacts in the intermediate images.

Third, smoothness including well-defined differentiability properties of the sinusoidal functions facilitate computing derivatives in closed form—e.g., represented as analytical functions such as sinusoidal functions, sine or co-sine functions, etc.—using (e.g., readily available, automatic, etc.) relatively simple differentiation operations. This may be important or beneficial for implicit regularization and/or error back-propagation and/or parameter optimization of the (neural implicit) image warping/morphing or view transition process, as these properties enable the neural network to produce, generate, predict or maintain smooth and consistent transformations across the entire images (e.g., for the intermediate views, etc.).

These strengths, attributes or factors of coordinate-based neural networks can be leveraged under techniques as described herein to achieve a relatively high level of accuracy and image detail in image morphing operations and provide visually pleasing and physically valid intermediate images. These networks can be used to not only enhance morphing quality but also ensure that resultant transformations are consistent with underlying geometries of visual scenes, objects, characters or image features depicted or (explicitly or implicitly) represented in videos/images.

As a result, MLP and SIREN networks used for implicit morphing or image warping as described herein can provide or achieve relatively high quality (e.g., in terms of PSNR measurements performed on the images, etc.) continuous or differentiable transformations that map or transform points of the source image of the source view to points of the target image of the target view and vice versa, as well as map or transform the points of the source and target images of the source and target views to points of intermediate images of intermediate views in original and rectified image spaces of these images.

A neural network such as an MLP or SIREN network may be used to learn, approximate, or optimize a morphing function used to effectuate or carry out a (neural network based or neural implicit) image morphing/warping or view transition process. This morphing function learned, approximated or optimized with the MLP or SIREN network may be generally denoted as M(⋅): [symbol] ²×[0,1]→ [symbol] ² where [0,1] denotes two endpoints demarcating a plurality of steps or timepoints corresponding to a plurality of intermediate images of a plurality of intermediate views in the (generated or optimized) view transition.

Additionally, optionally or alternatively, the morphing function used to carry out the (neural implicit) image morphing with the MLP or SIREN network may be parametrized with parameters θ as (a parametrized morphing function) M_{θ}(⋅), where θ represents operational parameters of the MLP or SIREN as a fully-connected network, for example optimized using gradient descent. A temporal transition of image morphing between two endpoint views may be effectuated or carried out with the parametrized morphing function M_{θ(⋅)}: [symbol] ²×[0,1]→ [symbol] ².

More specifically, for each step or timepoint t∈[0,1] in the view transition process of (neural implicit) image morphing, the parametrized morphing function M_{θ(⋅)} uses the step or timepoint t along with image coordinates or pixel locations as input (of the MLP or SIREN network) to predict, provide or generate an image coordinate mapping that can be used to map from an image of one domain (e.g., one image space, one image plane, one set of pixel arrays, etc.) to a corresponding image of another domain (e.g., another image space, another image plane, another set of pixel arrays, etc.).

Hence, over the plurality of steps or timepoints in [0,1], the parametrized morphing function M_{θ(⋅)} can be used to predict, provide or generate a plurality image coordinate mappings with varying t that result in a view transition between two viewpoints corresponding to the two endpoint views (corresponding to t or T being 0 or 1, respectively, in FIG. 2C).

Given a set or plurality of n (matching) landmarks/keypoints between a pair of endpoint views or source/target images,

$${\{ {p}_{j} , {q}_{j} \}}_{j = 1}^{n} ,$$

each of n curves or trajectories formed—by mapped landmarks/keypoints using M_{θ}(pⱼ, t) or M_{θ}(qⱼ, t)—in the intermediate images (or views) over the steps or timepoints t∈[0,1] have pⱼ and qⱼ as two end points.

A first set of n curves or trajectories may be formed by the mapped landmarks/keypoints using M_{θ}(pⱼ, t), whereas a second set of n curves or trajectories may be formed by the mapped landmarks/keypoints using M_{θ}(qⱼ, t). For each step or timepoint t∈[0,1], two curves or trajectories generated by M_{θ}(pⱼ, t) or M_{θ}(qⱼ, t) respectively may be aligned, or M_{θ}(pⱼ, t) equal to M_{θ}(qⱼ, 1−t). Accordingly, as illustrated in FIG. 2C, pixel values from both ends I₀(M_{θ}(pⱼ, t)) and I₁(M_{θ}(qⱼ, 1−t)) may be blended along a path to render the view transition, for example with a linear blending as follows:

$${I}_{blended} ( {M}_{θ} ( {p}_{j} , t ) ) = ( 1 - t ) \cdot {I}_{0} ( {M}_{θ} ( {p}_{j} , t ) ) + t \cdot {I}_{1} ( {M}_{θ} ( {q}_{j} , 1 - t ) ) \qquad ( 11 )$$

Parameterizing the view transition or transformation (process) of image morphing with the MLP or SIREN network make it relatively efficient or effective to utilize gradient descent to find or generate the (optimized) morphing function with optimized values for the operational parameters of the MLP or SIREN network. For example, by leveraging well-behaved differentiability of sinusoidal functions and gradient descent optimization, the operational parameters θ (e.g., weights, biases, etc.) of the MLP or SIREN network can be iteratively updated to minimize a loss function that measures the discrepancy between a predicted morphing or image mapping functions and the desired image transitions or mappings. The smoothness and differentiability of the SIREN architecture facilitate efficient backpropagation, allowing the gradients to be calculated relatively accurately and the operational parameters to be adjusted relatively precisely.

The MLP or SIREN with sinusoidal activation functions is advantageous for modeling continuous and visually natural view transitions or transformations. The periodic nature of the sine functions enables the MLP or SIREN network to capture relatively fine details and complex variations in videos/images, which is important or beneficial for maintaining relatively high fidelity during the image morphing or view transition process. For example, the inherent ability of the MLP or SIREN as described herein to model high frequency components or details ensures that the image morphing function can represent relatively subtle changes in the resultant intermediate images, leading to more realistic and natural-looking transitions than otherwise. This approach not only enhances image morphing/mapping/transition/transformation quality but also ensures such image morphing/mapping/transition/transformation to adhere to underlying geometric and physical constraints in the generated videos/images.

### 5. Auxiliary and Main Neural Networks

Neural network based (or neural implicit) morphing techniques under other approaches may create image transitions. However, these other approaches do not ensure that the resulting transitions appear natural. As illustrated in FIG. 2D (cited from Seitz, Steven M., and Charles R. Dyer, “View morphing,” Proceedings of the 23rd annual conference on Computer graphics and interactive techniques (1996)), interpolated viewpoints in the view transition under the other approaches may not be physically valid/accurate and can suffer serious visually perceptible distortions. For example, a relatively simple linear interpolation of pixel motions may not convey physically valid 3D rigid shape transformations. As a result, morphing networks under the other approaches fail to produce a visually reasonable transition effect.

To address these challenges, morphing techniques as described herein may be implemented to synthesize views with relatively simple 2D image operations under a monotonicity constraint between the two viewpoints. The monotonicity constraint is satisfied if a relative ordering of visual scene points along epipolar line(s) of the two viewpoints is preserved by the synthesized views. In other words, if the visual scene points appear in the same order in two different images in the set of images of the view transition, then the view transition is well-posed or depicts scene with physically valid views.

More specifically, let p₀∈I₀ and p₁∈I₁ be projections or pixels in images I₀ and I₁, respectively, of a scene point P=[X, Y, Z, 1]^{T}. Consider a special case in which the image (or photograph/picture) I₀ is taken of a visual (or visually perceptible) object by a camera. The object may be moved in a spatial direction—or within a spatial plane—parallel to the image plane of the (e.g., stationary, etc.) camera. The camera may zoom out and take a second image (or photograph/picture) I₁. In this case, the monotonicity will hold between I₀ and I₁. The projections or pixels p₀ and p₁ may relate to the scene point P in a linear relation as follows:

$$( 1 - s ) {p}_{0} + {sp}_{1} = ( 1 - s ) \frac{1}{z} {\prod }_{0} P + s \frac{1}{z} {\prod }_{1} P = \frac{1}{z} {\prod }_{s} P \qquad ( 12 - 1 )$$

$${\prod }_{s} = ( 1 - s ) {\prod }_{0} + s {\prod }_{1} \qquad ( 12 - 2 )$$

where s∈[0,1] denotes intermediate steps or timepoints between the two viewpoints; H denotes a projection matrix of a view corresponding to one of the two viewpoints or an intermediate view at an intermediate step or timepoint s.

In some operational scenarios, pairs of images may be used to calculate homography transformation matrices using matching points in the images and fundamental matrixes (e.g., derived from the matching points). Non-neural-network based image morphing may be directly performed in a rectified image space and re-projecting (or un-projecting) or inversely projecting pixels of images represented in the rectified image space back to original image space(s) to obtain a visually convincing transition. However, such non-neural-network based image morphing relies on using image feature correspondences to perform local affine transformation and still fails to produce a visually pleasing transition for image regions with sparse matching points. In addition, many pixels could be discarded during the homography transformations, resulting in image holes in the final transitioned intermediate images. For example, a rectified image space may represent a relatively heavy transformation (with heavily tilted image) in which many pixels to be tracked may be lost, giving rise to image holes in the intermediate images in the original image space(s). In some operational scenarios, the rectified image space may represent an image space constructed based at least in part on aligning with an epipolar line formed by (e.g., optical axes and image planes of, etc.) two cameras used to capture two endpoint images in a view transition as described herein.

Under techniques as described herein, base images (or non-interpolated non-morphed images) in their original image spaces are transformed to rectified images in a rectified image space (or a set of coplanar image spaces coinciding with one another). A (spatial monotonicity) order of visual scene points is maintained in the rectified images in the rectified image. These rectified images may be used to train or pre-train AI/ML models as described herein to generate physically valid intermediate images in the rectified image space or non-rectified image spaces such as original image spaces in which a view transition is generated. Even if a rectified image space may represent a relatively heavy transformation (with heavily tilted image), image data in the rectified image space is not directly transformed into corresponding image data in the intermediate data, but rather is used as (e.g., only, etc.) guidance for pre-training or jointly training the AI/ML models such as an auxiliary network operating in the rectified image space and a main network operating in original image space(s). As a result, the main network is still trained to relatively carefully track pixels in the original image space(s) and therefore is capable of generating or predicting reasonable image data such as image textures in the intermediate images without image holes or visually perceptible artifacts.

The AI/ML models in the view transition (or image morphing/warping) pipeline may include or comprise an auxiliary (or teacher/tutor) MLP or SIREN network and a main MLP or SIREN network.

In various operational scenarios, these networks may be separately trained and/or jointly trained. For example, in some operational scenarios as illustrated with dash line in FIG. 1A, the pretraining stage of block 104 to pre-train the auxiliary network may be skipped; only the joint training stage of block 106 to jointly train both auxiliary and main networks is performed or implemented.

In comparison, in some operational scenarios, as illustrated in blocks 104 and 106 of FIG. 1A, the auxiliary network may be pre-trained in block 104 of FIG. 1A, followed by jointly training both auxiliary and main networks in block 106 of FIG. 1A.

In the inference stage of block 108 of FIG. 1A, regardless of whether or not the pre-training stage of block 104 of FIG. 1A is performed or implemented, only (an instance on an end user device of) the main network—operating with (e.g., frozen, etc.) optimized operational parameters of the main network as optimized in the joint training stage of block 106 of FIG. 1A—is used to carry out a specific view transition between source and target images of different views represented in different (e.g., non-coplanar, etc.) original image spaces.

FIG. 1C illustrates an example pre-training stage (e.g., block 104 of FIG. 1A, etc.) in the view transition training and inference pipeline. Landmarks/keypoints represented in the image feature correspondences as determined in the source and target images and transformed into a rectified image space may serve as input or a part thereof to train the auxiliary (or teacher/tutor) morphing network. Additionally, optionally or alternatively, the rectified source and target images transformed from the source and target images of the original image spaces to the rectified image space may also serve as input or another part thereof to train the auxiliary (or teacher/tutor) morphing network.

In the pre-training stage of block 104 of FIG. 1A, the auxiliary morphing network extracts features from the received input and predicts or generates a view transition in the rectified image space between the source image and target image. A first loss function may be used to compute a first loss (e.g., error, cost, etc.) in its predicted view transition or intermediate images of intermediate views forming the predicted view transition. The first loss can be back-propagated in network layers or neural network nodes therein in the auxiliary morphing network to optimize operational parameters such as weights and biases used in these network layers or nodes in the auxiliary morphing network.

FIG. 1D illustrates an example joint training stage (e.g., 106 of FIG. 1A, etc.) in the view transition training and inference pipeline. The same landmarks/keypoints represented in the image feature correspondences as determined in the source and target images and transformed into a rectified image space—which may be used in the pretraining stage of block 104 of FIG. 1A—may serve as input or a part thereof to operate or train the auxiliary (or teacher/tutor) morphing network jointly with a main morphing network. Additionally, optionally or alternatively, the rectified source and target images transformed from the source and target images of the original image spaces to the rectified image space—which may be used in the pretraining stage of block 104 of FIG. 1A—may also serve as input or another part thereof to operate or train the auxiliary (or teacher/tutor) morphing network jointly with the main morphing network.

In comparison, landmarks/keypoints represented in the image feature correspondences as determined in the source and target images in their original image spaces—which have not been used in the pretraining stage of block 104 of FIG. 1A—may serve as input or a part thereof to train the main morphing network operating jointly with the auxiliary morphing network. Additionally, optionally or alternatively, the source and target images in the original image spaces—which have not been used in the pretraining stage of block 104 of FIG. 1A—may also serve as input or another part thereof to train the main morphing network operating jointly with the auxiliary morphing network.

The main morphing network may be referred to as a neural implicit morphing network as it is fully capable of carrying out a view transition in original image space(s) on its own in the inference stage (e.g., 108 of FIG. 1A, etc.) without the auxiliary network.

In operational scenarios in which the auxiliary morphing network has not been pretrained (e.g., block 104 of FIG. 1A is skipped in these operational scenarios, etc.), the auxiliary morphing network may be trained—the operational parameters of the auxiliary morphing network are not frozen but rather are subjected to optimizations or updates/changes or improvements—in the joint training stage of block 106 with the main morphing network in at least a part of all epochs (or training intervals/steps).

In operational scenarios in which the auxiliary morphing network has been pretrained (e.g., block 104 of FIG. 1A is not skipped in these operational scenarios, etc.), the auxiliary morphing network may or may not be trained in the joint training stage of block 106 with the main morphing network. In some operational scenarios, the auxiliary morphing network may not be trained—the operational parameters of the auxiliary morphing network are frozen and are not subjected to optimizations or updates/changes or improvements—in the joint training stage of block 106 with the main morphing network for all the epochs during which the main morphing network is being trained. In some operational scenarios, the auxiliary morphing network may still be trained—the operational parameters of the auxiliary morphing network are not frozen but rather are subjected to optimizations or updates/changes or improvements—in the joint training stage of block 106 with the main morphing network in at least a part of all epochs (or training intervals/steps).

In the joint training stage of block 106 of FIG. 1A, the auxiliary morphing network extracts features from its received input and predicts or generates a view transition in the rectified image space between the source image and target image. The predicted view transition or predicted intermediate images therein or predicted landmarks/keypoints in the predicted intermediate images of the predicted view transition in the rectified image space may be used to supervise training operations relating to or optimizing operational parameters of the main morphing network. More specifically, the predicted view transition or predicted intermediate images therein or predicted landmarks/keypoints in the predicted intermediate images of the predicted view transition such as coordinates of pixels in the predicted or output images generated from the auxiliary network and represented in the rectified image space can be inversely spatially transformed or projected back (with homography transformations) to their respective original image spaces and used in a second loss function to calculate or measure a second loss (e.g., a second error, a second cost, etc.) in a predicted corresponding view transition in original image spaces as generated or predicted by the main morphing network.

Likewise, the main morphing network extracts features from its received input and predicts or generates the corresponding view transition in the original image spaces between the source image and target image. The predicted corresponding view transition or predicted intermediate images therein or predicted landmarks/keypoints in the predicted intermediate images of the predicted corresponding view transition in the original image spaces as generated by the main morphing network may be used along with the predicted view transition or predicted intermediate images therein or predicted landmarks/keypoints in the predicted intermediate images of the predicted view transition in the rectified image space as generated by the auxiliary morphing network in the second loss function to calculate or measure the second in the predicted view transition in the original image spaces generated or predicted by the main morphing network. The second loss can be back-propagated in network layers or neural network nodes therein in the main morphing network to optimize operational parameters such as weights and biases used in these network layers or nodes in the main morphing network.

In any given epoch among a plurality of epochs during the joint training stage of Block 106 of FIG. 1A, if not subjected to training, then the operational parameters of the auxiliary network are frozen in that epoch. On the other hand, if subjected to training (hence the operational parameters of the auxiliary network are not frozen but rather are subjected to optimization, updates/changes or improvements) in that epoch, the first loss function may be used to compute a first loss (e.g., error, cost, etc.) in its predicted view transition or intermediate images of intermediate views forming the predicted view transition. The first loss can be back-propagated in network layers or neural network nodes therein in the auxiliary morphing network to optimize operational parameters such as weights and biases used in these network layers or nodes in the auxiliary morphing network.

Therefore, in some operational scenarios, a joint-training strategy may be implemented to pretrain an auxiliary morphing network in the rectified image space or domain. Rectified images (or images represented in the rectified image space/domain) simplify spatial or temporal relationships between corresponding spatial points and/or spatial directions by aligning epipolar lines of the source and target images, thereby reducing complexities of transformations the auxiliary morphing network needs to learn. This alignment with the rectified image space or domain enables the auxiliary morphing network to focus on learning relatively smooth and consistent transitions without being confounded by distortions or inconsistencies present in the original images (or images represented in the original image spaces/domain).

Furthermore, a morphing network as described herein such as the auxiliary morphing network and the main morphing network may be implemented as a coordinate-base neural network capable of predicting smooth and continuous transformations of pixels. Hence, the auxiliary morphing network can preserve relatively rich (e.g., image, texture, etc.) information in its predicted view transition for acting as a teacher/tutor network and supervising the training of the main morphing network in the original image spaces/domain.

In some operational scenarios in which a two-stage training strategy is implemented, the auxiliary (teacher/tutor) network can provide guidance or supervision based on its prior training or learning and help train the main morphing network to achieve a visually, perceptually or physically valid view transition in the relatively complex original image spaces/domain. This two-stage training strategy or approach not only improves image morphing (or view transition) results but also enhances overall robustness and reliability of the image morphing pipeline or framework.

### 6. Loss Functions

An overall loss function as described herein such as the first loss function for training the auxiliary morphing network and the second loss function for training the main (or neural implicit) morphing network can be specified or defined to include or combine several (component) loss functions or several loss function types. The overall loss function can compute an overall loss by combining (with or without weights) component losses (or component errors/costs) determined with the (component) loss functions or function types. The overall loss can be used to help ensure the morphing networks to learn and produce relatively accurate morphing transformations representing a morphing function used in a view transition in the rectified and original image spaces/domains.

A first component loss function or function type may be used to calculate a first component loss referred to as a halfway-domain constraint loss. This component loss aims to train the operational parameters θ of a sinusoidal morphing network such as an MLP or SIREN network M_{θ}(⋅) to approximate a warping/morphing operation that aligns the n matching landmarks/keypoints pⱼ and qⱼ along some or all the steps or timepoints t in the view transition. The first component loss function or the first component loss not only enforces data consistency between the morphing network's output/prediction and the landmarks/keypoints in the source and target images but also ensures the morphing network's output/prediction to match corresponding landmarks/keypoints (in the target or intermediate images) at some or all steps or timepoints, thereby maintaining consistency during intermediate transformations alone both the forward and backward directions. An example of the first component loss function may be defined or specified as follows:

$$ℋ ( θ ) = {\sum }_{j ∈ [ n ]} {\int }_{[ 0 , 1 ]} {\vert {M}_{θ} ( {p}_{j} , t ) - {M}_{θ} ( {q}_{j} , 1 - t ) \vert}^{2} dt \qquad ( 13 )$$

A second component loss function or function type may be used to calculate a second component loss referred to as an inverse constraint loss. This component loss aims to impose inverse constraints on the morphing network to help ensure consistency and invertibility. Through this component loss, it may be ensured that applying an inverse transformation to the morphing network's output returns (original image/pixel data at) original input coordinates.

Let Ω denote a (source image) space or spatial domain of the source image and x denote a 2D image coordinate within Ω. An example of the second component loss function may be defined or specified as follows:

$$𝒥 ( θ ) = {\sum }_{x ∈ Ω} {\int }_{[ 0 , 1 ]} \vert {M}_{θ} ( {M}_{θ} ( x , t ) , - t ) - x {\vert}^{2} dt \qquad ( 14 )$$

A third component loss function or function type may be used to calculate a third component loss referred to as a distance adaptive thin plate spline (TPS) loss. This component loss aims to provide a TPS regularization to help ensure relatively smooth deformations—e.g., geodesic, less wiggly, corresponding to a relatively straight line in the rectified image space, etc. —of visual objects or shapes in intermediate images of a view transition. This involves computing the Hessian (∇²) of the morphing network's output/prediction with respect to input (pixel) coordinates/locations and minimizing its squared values, as follows:

$${𝒯}_{c} ( θ ) = {\sum }_{x ∈ Ω} {\int }_{[ 0 , 1 ]} {\vert {∇}^{2} ( {M}_{θ} ( x , t ) ) \vert}^{2} dt \qquad ( 15 )$$

However, in view morphing, different pixels may undergo varying lengths, displacements or distances of motion paths during a transition between or among different views. This is possibly due to variations in scene or pixel depths at various coordinates/locations as well as influences from the (logical or physical) camera rotations and translations and amounts/magnitudes thereof. Hence, applying a TPS regularization in expression (15) above across all pixels can lead to an imbalance such that pixels undergoing relatively large motions disproportionately dominate this component loss function or component loss. This imbalance can cause instability during training and hinder convergence.

To address this issue, in some operational scenarios, a novel or different component loss function, which may be referred to a distance-adaptive thin-plate spline (DA-TPS) loss function, may be used—in place of or in addition to the loss function in expression (15) above—to adjust or provide the TPS regularization based at least in part on motion amounts/magnitudes of each pixel. Specifically, this TPS loss function (DA-TPS) may be inversely proportional to distances to (or between/among) matching features in the source image or view, as follows:

$$𝒯 ( θ ) = {\sum }_{x ∈ Ω} {\int }_{[ 0 , 1 ]} w ( x ) {\vert {∇}^{2} ( {M}_{θ} ( x , t ) ) \vert}^{2} dt \qquad ( 16 )$$

where ∇² denotes the Hessian operator. The weight function w(⋅) modulates the influence of the TPS regularization at each (image pixel) coordinate/location based on its motion magnitude. This weighting scheme or function effectively reduces the influence of pixels undergoing relatively large motions in the TPS loss, thereby preventing these pixels from dominating the training process of the morphing network.

In some operational scenarios, for the predetermined (or predefined in the training stage(s)) matching landmarks/keypoints, the weights in expression (16) above may be computed using an inverse quadratic function of the normalized distance, as follows:

$$w ( {p}_{j} ) = w ( {q}_{j} ) = \frac{1}{( 1 + {( \frac{{d}_{j}}{{d}_{max}} )}^{2} )} \qquad ( 17 )$$

where dⱼ=|pⱼ−qⱼ|; dₘₐₓ represents the maximum distance among all matching pairs. Reducing TPS regularization on relatively long trajectories under this scheme allows the morphing network to handle relatively large transformations flexibly, thereby leading to relatively natural morphing produced or predicted by the morphing network. In addition, this scheme keeps or maintains stronger regularization for relatively short trajectories, which in turn maintains smoothness and relatively subtle, gradual changes as expected or intended, thereby improving overall visual coherence in the view transition produced with the morphing network.

In some operational scenarios, for pixels other than or without predefined matching landmarks/keypoints, the weights w(⋅) can be computed by interpolating the weights from the known or predetermined matching points using a Gaussian kernel, as follows:

$$w ( x ) = {\sum }_{j} {G}_{σ} ( x - {p}_{j} ) w ( {p}_{j} ) \qquad ( 18 )$$

where G_{σ} represents a Gaussian function defined as follows:

$${G}_{σ} = \frac{1}{2 π {σ}^{2}} exp ( - \frac{{\vert x \vert}^{2}}{2 {σ}^{2}} ) \qquad ( 19 )$$

where σ represents a hyperparameter used to control spatial spreads or distributions of the weights. This interpolation spreads or distributes the weights from the matching landmarks/keypoints to their surrounding pixels, ensuring a relatively smooth spatial distribution of weight values.

A fourth component loss function or function type may be used to calculate a fourth component loss referred to as a linear interpolation loss. This loss may be used (e.g., only, etc.) for the auxiliary (teacher/tutor) morphing network M_{φ} trained in the rectified image space/domain. Let \hat{p}ⱼ and \hat{q}ⱼ denote corresponding matching landmarks/keypoints in the rectified source and target images Î₀ and Î₁, respectively. This loss (term) can be used to help ensure that intermediate coordinates predicted by the morphing network to align along a linear trajectory between \hat{p}ⱼ and \hat{q}ⱼ. An example of the fourth component loss function may be specified or defined as follows:

$$𝒫 ( ϕ ) = {\sum }_{j ∈ [ n ]} {\int }_{[ 0 , 1 ]} {\vert {M}_{ϕ} ( {\hat{p}}_{j} , t ) - ( ( 1 - t ) {\hat{p}}_{j} + t {\hat{q}}_{j} ) \vert}^{2} dt \qquad ( 20 )$$

A fifth component loss function or function type may be used to calculate a fifth component loss referred to as a knowledge transfer loss. Motions as learned from or predicted by the auxiliary (teacher/tutor) morphing network M(operating in the rectified image space or domain are used to supervise the main morphing network Me operating in the original image space. More specifically, the fifth component loss function can be used to compute a loss that encourages the main morphing network Me to produce or predict pixel motions consistent with those produced or predicted by the auxiliary (teacher/tutor) morphing network M(after accounting for—or the prediction pixel motions from the auxiliary morphing network being applied—with homography transformations. The two morphing networks can be optimized in a sequential or (at least partly) concurrent manner by training and freezing/unfreezing the auxiliary (teacher/tutor) network before (in the pretraining stage) or while (in the joint training stage) training the main morphing network. An example of the fifth component loss function can be specified or defined as follows:

$$ℛ ( θ , ϕ ) = {\sum }_{x ∈ Ω} {\int }_{[ 0 , 1 ]} {\vert {M}_{θ} ( x , t ) - H ( t ) {M}_{ϕ} ( \hat{x} , t ) \vert}^{2} dt \qquad ( 21 )$$

where \hat{x} represents (image pixel) coordinates in the rectified image space/domain. In some operational scenarios, a respective homography transformation at a step or timepoint t, denoted as H(t), can be approximated via a linear interpolation of (endpoint) homography transformations H(0) and H(1), as pre-determined in the data pre-processing stage for the source and target images between their original image spaces and the rectified image space.

In some operational scenarios, an overall loss functions for the auxiliary (teacher/tutor) morphing network M_{φ} can be represented as follows:

$${L}_{teacher} ( ϕ ) = {α}_{ℋ} ℋ ( ϕ ) + {α}_{𝒥} 𝒥 ( ϕ ) + {α}_{𝒯} 𝒯 ( ϕ ) + {α}_{𝒫} 𝒫 ( ϕ ) \qquad ( 22 )$$

where α represents hyperparameters used to control a specific contribution of each constraint or a corresponding component loss function used to help ensure the constraint; φ represents operational parameters of the auxiliary morphing network.

In comparison, an overall loss function for the main morphing network M_{θ} can be represented as follows:

$${L}_{main} ( θ , ϕ ) = {α}_{ℋ} ℋ ( θ ) + {α}_{𝒥} 𝒥 ( θ ) + {α}_{𝒯} 𝒯 ( θ ) + {α}_{ℛ} ℛ ( θ , ϕ ) \qquad ( 23 )$$

where α represents hyperparameters—which may or may not be the same as those for the auxiliary morphing network even for the same component loss function types—used to control a specific contribution of each constraint or a corresponding component loss function used to help ensure the constraint; θ and φ represent the operational parameters of the main and auxiliary morphing networks, respectively.

### 7. Main Neural Network Inferencing

FIG. 1E illustrates an example inference stage (e.g., 108 of FIG. 1A, etc.) in the view transition training and inference pipeline. In some operational scenarios, the inference stage can be operated with the (trained) main morphing network entirely on its own without the auxiliary morphing network. More specifically, the trained main morphing network or the neural implicit morphing network may receive two images View 0 and View 1 as source and target images of different views in original image spaces, for example along with matching landmarks/keypoints in these images. The source and target images in the original image spaces and the matching landmarks/keypoints may be used by the neural implicit morphing network to perform (e.g., real-time, with time latency strictly within a relatively short time latency budget, etc.) inference including but not limited to perform (e.g., neural implicit, neural network based, etc) coordinate mapping or transformation of image data on the source and target images to generate or predict intermediate image data values—e.g., denoted as M_{θ}(x, y, t=0.3) and M_{θ}(x, y, t=0.8)—at different input coordinates or locations at one or more steps or timepoints. These input coordinates or locations may or may not form a two-dimensional array of image pixel coordinates or locations forming an overall intermediate image frame.

As illustrated in FIG. 1E, specific coordinates or locations representing image pixel coordinates or locations forming an overall intermediate image frame at a specific step or timepoint t may be received as a part of the input by the neural implicit morphing network to perform (e.g., real-time, at a relatively high frame per second or FPS rate, at a relatively high image refresh rate, etc.) image pixel resampling or generate or predict intermediate image pixel values at these image pixel coordinates or locations forming the intermediate image for the specific step or timepoint t. For example, at a first specific step or timepoint t=0.3, predicted image pixel values at pixel coordinates or locations denoted as x_{0.3}, y_{0.3} may be generated from the neural implicit morphing network to form a first intermediate image (with a first intermediate view denoted as View 0.3) for the first specific step or timepoint t=0.3. Similarly, at a second specific step or timepoint t=0.8, predicted image pixel values at pixel coordinates or locations denoted as x_{0.8}, y_{0.8} may be generated from the neural implicit morphing network to form a second intermediate image (with a second intermediate view denoted as View 0.8) for the second specific step or timepoint t=0.8.

FIG. 2E illustrates an example view transition, which may be generated by an image morphing or view transition pipeline or a neural implicit image morphing (or view transition) model therein. This view transition is carried out as a task aiming to generate a continuous series of interpolated images/frames or their corresponding views starting at one endpoint viewpoint (represented by an enclosed camera symbol depicted on the left) and ending at another endpoint viewpoint (represented by an enclosed camera symbol depicted on the right). The neural implicit morphing model after training or joint training can operate with optimized operational parameters generated during training with (e.g., only, etc.) the two endpoint viewpoints or observations as available input data to generate the continuous series of interpolated (or warped/morphed) images that may provide a relatively natural, smooth and physically or perceptually valid view transition, for example in the form of a video slip or a portion thereof.

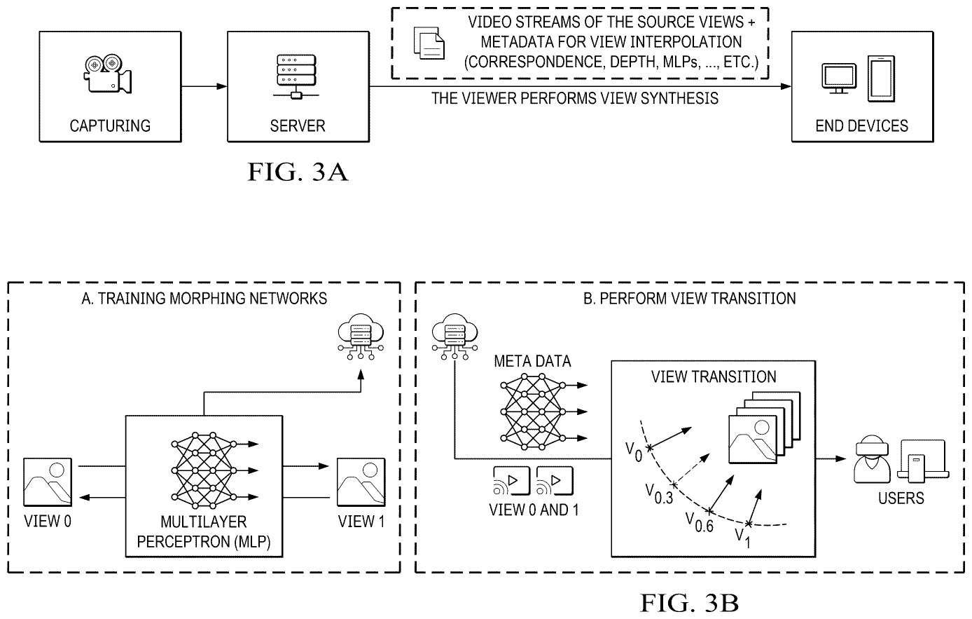

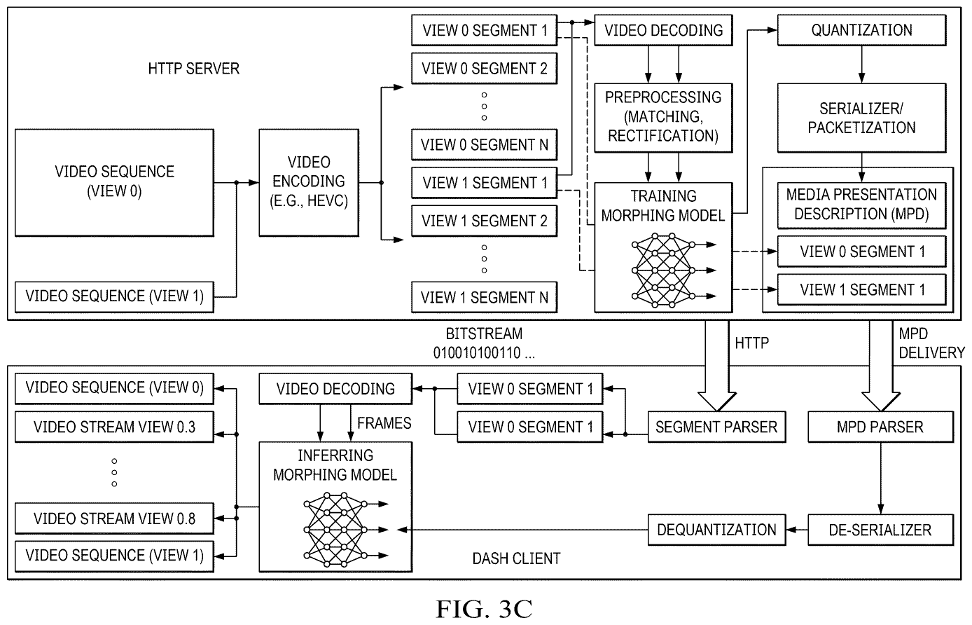

FIG. 3A illustrates an example use case or operational scenario relating to an image morphing or view transition pipeline as described herein. Videos/images of different source and target views (e.g., two views, more than two views, etc.) may be (e.g., concurrently, etc.) captured from the same visual scenes by multiple cameras or camera elements with different viewpoints. An AI/ML based server system may be implemented with—or may operate in conjunction with separate system(s) that implement—AI/ML models including neural implicit AI/ML models operating in original image spaces—for example, including but not limited to original image spaces associated with the viewpoints of the cameras—for image morphing or view transition operations. The neural implicit AI/ML models may be trained with auxiliary (or teacher/tutor) image morphing models operating in rectified image spaces in which some or all images acquired by the cameras may be transformed with homography transformations (or transformation matrices). As a result, the neural implicit AI/MO models may operate with optimized operational parameters to (e.g., consistently, smoothly, in a physically or perceptually valid manner, etc.) generate or predict interpolated or morphed images from either source videos/images captured by a source camera (e.g., a specific camera among the cameras, etc.) or target videos/images captured by a target camera (e.g., a different specific camera among the cameras, etc.) or both.

By sending image metadata comprising feature correspondences or matched landmarks/keypoints, view or depth data, etc., as well as learned, trained or optimized operational parameters of the neural implicit morphing models (which may be MLP or SIREN networks) for image/view interpolation or morphing along with visual contents such as video streams including source (and/or target) images of source views (e.g., one or more specific cameras in the cameras, etc.) to end devices operated by viewers, these viewers can perform, or cause the end devices to perform, view interpolation/syntheses by actively selecting their (e.g., preferred, desired, intended, source and/or target, etc.) viewpoints, thereby providing a relatively interactive and immersive viewing experience.

FIG. 3B illustrates example operational scenarios in which video content providers can leverage overfitting properties of deep neural network (DNN) to train relatively lightweight neural (implicit) morphing models as described herein for each video segment in one or more video segments at one or more servers, for example in advance. Learned, trained or optimized operational parameters of these lightweight models can be sent as image (morphing) metadata to and received by end devices along with video streams comprising video data for some or all of the video segments. After receiving these video and metadata contents, a client or end device can apply the relatively lightweight morphing models/networks to decoded video frames in the video segments at a real-time throughput (e.g., >60 frame per second or FPS image refresh rate, etc.) to generate interpolated or morphed views (e.g., V_{0.3}, V_{0.6}, etc.) other than views such as View 0 and View 1 (or V₀ and V₁) represented in the received video data.

FIG. 3C illustrates an example process flow (or flowchart) of view transitioning and/or image morphing using trained or pre-trained neural implicit morphing models as described herein. By way of example but not limitation, a server system such as an HTTP or DASH (Dynamic Adaptive Streaming over HTTP) based system may be implemented on the server side, whereas a client system such as a DASH client device may be implemented on the client side to receive video contents from the server system using HTTP or DASH protocol operations. The video content from the server to the client may include two parts: image metadata in MPD (Media Presentation Description) and (encoded) video segments (e.g., for View 0 and View 1, etc.) or files each of which may cover a specific time duration and/or a specific view for the specific time duration.

As shown, the encoded video segments or files delivered to the DASH client may be generated from source (and/or target as each source view may also represent a target view to be switched from a different represented view) video segments through (e.g., HEVC, etc.) video encoding, video decoding, quantization, serialization/packetization, etc.

In comparison, the image metadata in the MPD delivered to the DASH client may be generated in part or in whole from learned, trained or optimized operational parameters of neural implicit morphing models/networks trained with decoded video segments of different source (and/target) views and some or all feature correspondences, matched landmarks/keypoints, view/depth data, etc.

On the client side, the DASH client may use MPD parser(s) to parse the received MPD data into the optimized operational parameters of the neural implicit morphing models/networks. The DASH client may use video segment parser(s) to parse the received encoded video segments into individual encoded video segments. Decoded video segments generated from the encoded video segments along with some or all of the learned, trained or optimized operational parameters of neural implicit morphing models/networks trained with decoded video segments of different source (and/target) views and some or all feature correspondences, matched landmarks/keypoints, view/depth data, etc., may be used to populate client-side AI/ML neural networks/models similar to or the same as—in terms of network layers or neurons—the trained neural implicit morphing models/networks on the server side. The AI/ML neural networks/models populated with these server-side generated video data and metadata may perform the same or similar image morphing operations as the trained neural implicit morphing models/networks on the server side to support view transitioning or image morphing operations including but not necessarily limited to generating images of intermediate or novel views such as View 0.3 and View 0.8 that are not represented in the received video segments by the DASH client.

Hence, under techniques as described herein, the optimized operational parameters of the relatively lightweight neural morphing networks/models can be stored and delivered as image metadata, which may be used to enable view transition at the client side. At the inference stage, these networks/models can be applied to the decoded video frames directly without any image processing including data preprocessing operations and training operations performed (e.g., entirely, etc.) on the server side.

### 8. Example Training Procedures

Example training procedures are illustrated in TABLEs 1 and 2 below. A first training procedure in TABLE 1 may be used to train or pretrain an auxiliary (or teacher/tutor) morphing network operating in a rectified image space/domain, whereas a second training procedure in TABLE 2 may be used to train or pretrain a main morphing network operating in original image spaces/domain. Both training procedures may involve iterating over the same or different data batches. Each data batch may be processed to extract training input data such as source and/or target images, feature detection, feature correspondence determination, pre-rectified coordinates or locations of matched landmarks/keypoints, etc., in the original image spaces, rectified coordinates or locations of matched landmarks/keypoints, etc., in the rectified image space, homography transformations (transformation matrices), and so forth.

As illustrated in TABLE 2, in the case of jointly optimizing both auxiliary (or teacher/tutor) and main networks, (e.g., pre-trained, etc.) operational parameters of the auxiliary (or teacher/tutor) network may be frozen for initial steps/epochs, for example until a user-specified joint training start step/epoch is reached. The loss function in expression (23) above may be used to train the main morphing network. Subsequently, the operational parameters of the auxiliary (or teacher/tutor) network may be unfrozen, both loss functions in expressions (22) and (23) may be used to jointly optimize both auxiliary and main networks' operational parameters such as weights and biases.

In both pre-training and joint training as illustrated in TABLES 1 and 2, an optimizer may perform optimization of operational parameters of the (unfrozen) neural network(s) by computing a total loss based on an applicable loss function—e.g., expression (22) and/or expression (23), etc.—through summing individual losses (or loss types) with system configured or user specified specified weights of these individual losses (or loss types). The optimizer can updates the (neural network) operational parameters through backpropagation.

TABLE 1
Algorithm 1 Pretrain Auxiliary Morphing Network

Require: Dataset [symbol] _{rec}, Neural Network M_{φ}, Optimizer opt, Loss function in
expression (22), Epochs N
1 for each epoch e ∈ {1, ... , N} do
2 dataloader ← get_dataloader( [symbol] _{rec})
3 for each batch in dataloader do
4 ${X}^{rec} , \{ {p}_{j}^{rec} , {q}_{j}^{rec} \} ← allocate\_data ( batch )$
5 $losses ← compute\_losses ( {M}_{ϕ} , {X}^{r e c} , {\{ {p}_{j}^{rec} , {q}_{j}^{rec} \}}^{n} )$
6 loss ← Σtorch.stack(losses) · loss_weights
7 opt.zero_grad( )
8 loss.backward(M_{φ})
9 end for
12 end for
13 return M_{φ}

After pretraining the auxiliary network M_{φ} in the rectified image space/domain using rectified space related training data, the main (or final) implicit morphing network M_{θ} operating in the original image spaces/domain may be trained using a complete training dataset that includes the rectified space related training data and original space related training data.

TABLE 2
Algorithm 2 Train Morphing Network

| Require: Dataset [symbol] , Neural Network M_{φ}, Optimizer opt, Loss functions in expression | |
|---|---|
| (22) and expression (23), Epochs N, Joint-training Step Tⱼ | |
| Ensure: Pretrained M_{φ} | |
| 1 | Freeze the parameters of M_{φ} |
| 2 | for each epoch e ∈ {1, ... , N} do |
| 3 | dataloader ← get_dataloader( [symbol] ,mode) |
| 4 | if e ≥ Tⱼ then |
| 5 | Unfreeze the parameters of M_{φ} |
| 6 | Endif |
| 7 | for each batch in dataloader do |
| 8 | $X , {\{ {p}_{j} , {q}_{j} \}}^{n} , {X}^{rec} , {\{ {p}_{j}^{rec} , {q}_{j}^{rec} \}}^{n} ← allocate\_data ( batch )$ |
| 9 | $losses ← compute\_losses ( {M}_{θ} , {M}_{ϕ} , X , {\{ {p}_{j} , {q}_{j} \}}^{n} , {X}^{rec} , {\{ {p}_{j}^{rec} , {q}_{j}^{rec} \}}^{n} )$ |
| 10 | loss ← Σtorch.stack(losses) · loss_weights |
| 11 | opt.zero_grad( ) |
| 12 | if e ≥ Tⱼ then |
| 13 | loss.backward(M_{θ}, M_{φ}) |
| 14 | Else |
| 15 | loss.backward(M_{θ}) |
| 16 | end if |
| 17 | end for |
| 18 | end for |
| 20 | return M_{θ} |

The auxiliary (or teacher/tutor) network M_{φ} may be solely utilized during the training phase(s) to guide training the main network M_{θ}. During the model inference or application phase, M_{φ} may not be involved, and hence can be discarded after training the main network M_{θ}. This enables image morphing operations performed at an end device not to incur additional computational overheads during inference in connection with the auxiliary (or teacher/tutor) network M_{φ}, thereby maintaining relatively high data and computational efficiency while at the same time improving video/image quality and physical/perceptual validity of generated view transitions or warped/morphed images therein.

Hyperparameters such as weights may be used for individual losses or loss types in the loss functions in expressions (22) and (23). A non-limiting example of these hyperparameters may be, but is not necessarily limited to only: [symbol] =1×10⁴, [symbol] =1×10⁴, [symbol] =1×10⁴, [symbol] =5×10³, and [symbol] =1×10³, respectively.

Under techniques as described herein, view transitions can be accomplished using coordinate-based neural networks to parametrize an image morphing function between source and target images and perform implicit morphing operations relatively smoothly between endpoint views represented in these images without any need for obtaining explicit 3D scene reconstruction or camera pose information from these images.

Under other approaches, deep learning-based methods that incur relatively computationally intensive inference with relatively heavy network architectures. In addition, virtual viewpoints produced by image morphing methods are usually not visually or physically convincing, as a physically valid intermediate view may not be a linear combination of two endpoint views.

In comparison, techniques as described herein may be used to implement a joint training strategy for pixel motion regularization. The joint training strategy employs an auxiliary network—which may be pretrained in a rectified image space and/or may be jointly trained in the rectified image space in various operational scenarios—to supervise a main morphing network. This joint strategy helps regularize motion paths generated by the main morphing network without depending on (e.g., explicit, etc.) pose and depth estimation and enhance physical or perceptual validity of interpolated views.

AI/ML models under techniques as described herein can be trained and applied in a relatively highly data and computationally efficient manner. For example, the auxiliary and/or main networks/models may be pre-trained or jointly trained in training stage(s) in the training stage(s), whereas relatively lightweighted models of these models may be applied to support view transitions during real-time operations of end devices operated by users (or viewers) in the inference stage. At inference, photorealistic view transition images can be generated in real-time since the main morphing network may be a relatively lightweight MLP. Thus, photorealistic, physically/perceptually valid, convincing view transitions can be achieved with relatively high quality/performance and/or relatively low time latency using (e.g., relatively small, with relatively few network layers or neurons, etc.) AI/ML models as described herein.

In some operational scenarios, a neural implicit morphing model under techniques as described herein may be implemented using a simple two-hidden-layer MLP (or a MLP with relatively few layers, thereby allowing for relatively efficient transmission of the neural implicit morphing model, which can be used to perform real-time inference with relatively low time latency. As a result, these techniques are well-suited for real-time interactive applications.

### 9. Example Process Flows

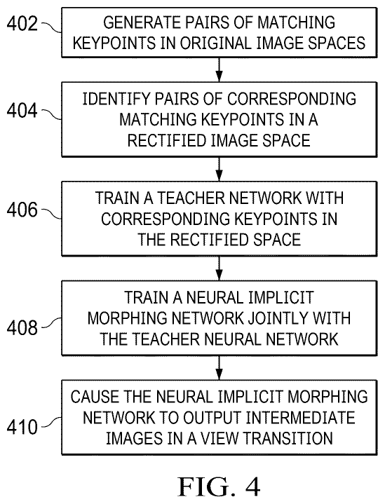

FIG. 4 illustrates an example process flow according to an embodiment. In some embodiments, one or more computing devices or components (e.g., an image generation system, a view transition system, an image morphing system, etc.) may perform this process flow. In block 402, a system described herein generates pairs of matching keypoints in original image spaces based at least in part on image feature correspondences established between two input images of two endpoint views for a view transition.

In block 404, the system identifies pairs of corresponding matching keypoints in a rectified image space based at least in part on homography transformation matrices derived from the pairs of matching keypoints in the original image spaces, each pair in the pairs of corresponding matching keypoints in the rectified image space corresponding to a respective pair in the pairs of matching keypoints in the original image spaces.

In block 406, the system trains a teacher neural network based at least in part on the pairs of corresponding matching keypoints in the rectified image space.

In block 408, the system trains a neural implicit morphing network jointly with the teacher neural network based at least in part on the pairs of matching keypoints in the original image spaces in which predictions outputted from the teacher neural network are used to compute a loss function designated to train the neural implicit morphing network.

In block 410, the system causes the neural implicit morphing network on its own, after training jointly with the teacher neural network, to output intermediate images in the view transition between the two endpoint views represented in the two input images.

In an embodiment, the system further causes display images derived from the two input images and the intermediate images in the view transition to be rendered on an image display of an end user device.

In an embodiment, the two input images represent a source image and a target image; a user operating with the end user device provides user input that is used to select the target image for the view transition.

In an embodiment, one or both of the teacher neural network and the neural implicit morphing network includes one or more of: a coordinate based neural network, a multi-layer perceptron network (MLP), a sinusoidal representation neural network (SIREN), etc.

In an embodiment, the teacher neural network and the neural implicit morphing network are trained with one or more server systems separate from the end user device to generate optimized operational parameters of the neural implicit morphing network; the end user device receives image data for the two input images along with optimized operational parameters used by the end user device to populate a client-side neural implicit morphing network corresponding to the neural implicit morphing network trained with the one or more server systems.

In an embodiment, the image data for the two input images is encoded in one or more of: video segments or video files or video bitstreams; wherein the optimized operational parameters are received by the end user device as image metadata for the image data.

In an embodiment, the end user device receives the image data and the image metadata using DASH (Dynamic Adaptive Streaming over HTTP) protocol operations; the image metadata is packaged as media presentation description (MPD) data.

In an embodiment, the neural implicit morphing network consists of only two MLP network layers.

In an embodiment, display images respectively derived from the two input images and the intermediate images in the view transition are rendered on an image display of the end user device with an image refresh rate of greater than 60 frames per second in a real time display application.

In an embodiment, the teacher neural network represents another neural implicit morphing network operating in the rectified image space.

In an embodiment, a first loss function is used to compute first losses used to optimize first operational parameters of the teacher neural network; a second different loss function is used to compute second losses used to optimize second operational parameters of the neural implicit morphing network.

In an embodiment, at least one of the first loss function and the second different loss function includes: one or more of: a halfway-domain constraint loss component function, an inverse constraint loss component function, a loss component function relating to thin-plate-spline (TPS) regularization, a linear interpolation loss component function, a knowledge transfer loss component function, etc.

In an embodiment, the teacher neural network is at least partly pre-trained before the teacher neural network is jointly trained with the neural implicit morphing network.

In an embodiment, a computing device such as a display device, a mobile device, a set-top box, a multimedia device, etc., is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Note that, although separate embodiments are discussed herein, any combination of embodiments and/or partial embodiments discussed herein may be combined to form further embodiments.

### 10. Implementation Mechanisms—Hardware Overview

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to the adaptive perceptual quantization of images with enhanced dynamic range, such as those described herein. The computer and/or IC may compute any of a variety of parameters or values that relate to the adaptive perceptual quantization processes described herein. The image and video embodiments may be implemented in hardware, software, firmware and various combinations thereof.

Certain implementations of the inventio comprise computer processors which execute software instructions which cause the processors to perform a method of the disclosure. For example, one or more processors in a display, an encoder, a set top box, a transcoder or the like may implement methods related to adaptive perceptual quantization of HDR images as described above by executing software instructions in a program memory accessible to the processors. Embodiments of the invention may also be provided in the form of a program product. The program product may comprise any non-transitory medium which carries a set of computer-readable signals comprising instructions which, when executed by a data processor, cause the data processor to execute a method of an embodiment of the invention. Program products according to embodiments of the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

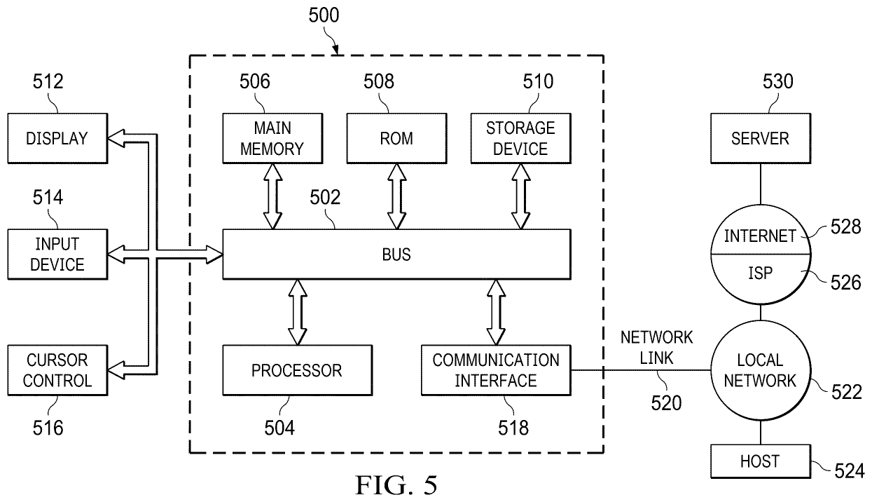

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display, for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques as described herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In other embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

Various aspects of the present disclosure may be appreciated from the following enumerated example embodiments (EEEs):
EEE 1. A method, comprising: generating pairs of matching keypoints in original image spaces based at least in part on image feature correspondences established between two input images of two endpoint views for a view transition; identifying pairs of corresponding matching keypoints in a rectified image space based at least in part on the pairs of matching keypoints in the original image spaces, each pair in the pairs of corresponding matching keypoints in the rectified image space corresponding to a respective pair in the pairs of matching keypoints in the original image spaces; training a teacher neural network based at least in part on the pairs of corresponding matching keypoints in the rectified image space; training a neural implicit morphing network jointly with the teacher neural network based at least in part on the pairs of matching keypoints in the original image spaces in which predictions outputted from the teacher neural network are used to compute a loss function designated to train the neural implicit morphing network.
EEE 2. The method as recited in EEE 1, wherein the pairs of corresponding matching keypoints in a rectified image space are identified based at least in part on homography transformation matrices derived from the pairs of matching keypoints in the original image spaces; the method further comprising: selecting a subset of pairs of matching keypoints from the pairs of matching keypoints; using the subset of pairs of matching keypoints to determine values of matrix elements of a fundamental matrix; applying decomposition to the fundamental matrix to obtain epipolar points relating to the two input points; determining the homography transformation matrices based at least in part on the epipolar points.
EEE 3. The method as recited in EEE 1 or 2, further comprising: causing display images derived from the two input images and the intermediate images in the view transition to be rendered on an image display of an end user device.
EEE 4. The method as recited in any of EEEs 1-3, wherein the two input images represent a source image and a target image; wherein a user operating with the end user device provides user input that is used to select the target image for the view transition.
EEE 5. The method as recited in EEE 4, wherein the source image and the target image represent one of: two images of a multi-view image comprising a set of single view images for a common time point, or two images for two different time points.
EEE 6. The method as recited in any of EEEs 1-5, wherein one or both of the teacher neural network and the neural implicit morphing network includes one or more of: a coordinate based neural network, a multi-layer perceptron network (MLP) or a sinusoidal representation neural network (SIREN).
EEE 7. The method as recited in any of EEEs 1-6, wherein the teacher neural network and the neural implicit morphing network are trained with one or more server systems separate from the end user device to generate optimized operational parameters of the neural implicit morphing network; wherein the end user device receives image data for the two input images along with optimized operational parameters used by the end user device to populate a client-side neural implicit morphing network corresponding to the neural implicit morphing network trained with the one or more server systems.
EEE 8. The method as recited in EEE 7, wherein the image data for the two input images is encoded in one or more of: video segments or video files or video bitstreams; wherein the optimized operational parameters are received by the end user device as image metadata for the image data.
EEE 9. The method as recited in EEE 8, wherein the end user device receives the image data and the image metadata using DASH (Dynamic Adaptive Streaming over HTTP) protocol operations; wherein the image metadata is packaged as media presentation description (MPD) data.
EEE 10. The method as recited in any of EEEs 1-9, wherein the neural implicit morphing network consists of only two MLP network layers.
EEE 11. The method as recited in any of EEEs 1-10, wherein the teacher neural network represents another neural implicit morphing network operating in the rectified image space.
EEE 12. The method as recited in any of EEEs 1-11, wherein a first loss function is used to compute first losses used to optimize first operational parameters of the teacher neural network; wherein a second different loss function is used to compute second losses used to optimize second operational parameters of the neural implicit morphing network.
EEE 13. The method as recited in any of EEEs 1-12, wherein at least one of the first loss function and the second different loss function includes: one or more of: a halfway-domain constraint loss component function used to train neural network operational parameters of a sinusoidal neural network to approximate an image warping operation that aligns matching landmarks/keypoints; an inverse constraint loss component function used to ensure consistency and invertibility in the view transition; a loss component function relating to thin-plate-spline (TPS) regularization used to ensure relatively smooth deformations; a linear interpolation loss component function used to ensure that intermediate coordinates predicted by a morphing network to align along a linear trajectory; or a knowledge transfer loss component function used to influence a student or main neural network to produce predictions consistent with predictions produced by a teacher neural network.
EEE 14. The method as recited in any of EEEs 1-13, wherein the teacher neural network is at least partly pre-trained before the teacher neural network is jointly trained with the neural implicit morphing network.
EEE 15. An apparatus performing any of the methods as recited in EEEs 1-14.

### 11. Equivalents, Extensions, Alternatives and Miscellaneous

In the foregoing specification, embodiments of the invention have been described with reference to numerous specific details that may vary from implementation to implementation. Thus, the sole and exclusive indicator of what is claimed embodiments of the invention, and is intended by the applicants to be claimed embodiments of the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method, comprising:
generating pairs of matching keypoints in original image spaces based at least in part on image feature correspondences established between two input images of two endpoint views for a view transition;
identifying pairs of corresponding matching keypoints in a rectified image space based at least in part on the pairs of matching keypoints in the original image spaces, each pair in the pairs of corresponding matching keypoints in the rectified image space corresponding to a respective pair in the pairs of matching keypoints in the original image spaces;
training a teacher neural network based at least in part on the pairs of corresponding matching keypoints in the rectified image space;
training a neural implicit morphing network jointly with the teacher neural network based at least in part on the pairs of matching keypoints in the original image spaces in which predictions outputted from the teacher neural network are used to compute a loss function designated to train the neural implicit morphing network.

2. The method as recited in claim 1, wherein the pairs of corresponding matching keypoints in a rectified image space are identified based at least in part on homography transformation matrices derived from the pairs of matching keypoints in the original image spaces; the method further comprising:
selecting a subset of pairs of matching keypoints from the pairs of matching keypoints;
using the subset of pairs of matching keypoints to determine values of matrix elements of a fundamental matrix;
applying decomposition to the fundamental matrix to obtain epipolar points relating to the two input points;
determining the homography transformation matrices based at least in part on the epipolar points.

3. The method as recited in claim 1, further comprising: causing display images derived from the two input images and the intermediate images in the view transition to be rendered on an image display of an end user device.

4. The method as recited in claim 1, wherein the two input images represent a source image and a target image; wherein a user operating with the end user device provides user input that is used to select the target image for the view transition.

5. The method as recited in claim 4, wherein the source image and the target image represent one of: two images of a multi-view image comprising a set of single view images for a common time point, or two images for two different time points.

6. The method as recited in claim 1, wherein one or both of the teacher neural network and the neural implicit morphing network includes one or more of: a coordinate based neural network, a multi-layer perceptron network (MLP) or a sinusoidal representation neural network (SIREN).

7. The method as recited in claim 1, wherein the teacher neural network and the neural implicit morphing network are trained with one or more server systems separate from the end user device to generate optimized operational parameters of the neural implicit morphing network; wherein the end user device receives image data for the two input images along with optimized operational parameters used by the end user device to populate a client-side neural implicit morphing network corresponding to the neural implicit morphing network trained with the one or more server systems.

8. The method as recited in claim 7, wherein the image data for the two input images is encoded in one or more of: video segments or video files or video bitstreams; wherein the optimized operational parameters are received by the end user device as image metadata for the image data.

9. The method as recited in claim 8, wherein the end user device receives the image data and the image metadata using DASH (Dynamic Adaptive Streaming over HTTP) protocol operations; wherein the image metadata is packaged as media presentation description (MPD) data.

10. The method as recited in claim 1, wherein the neural implicit morphing network consists of only two MLP network layers.

11. The method as recited in claim 1, wherein the teacher neural network represents another neural implicit morphing network operating in the rectified image space.

12. The method as recited in claim 1, wherein a first loss function is used to compute first losses used to optimize first operational parameters of the teacher neural network; wherein a second different loss function is used to compute second losses used to optimize second operational parameters of the neural implicit morphing network.

13. The method as recited in claim 1, wherein at least one of the first loss function and the second different loss function includes: one or more of: a halfway-domain constraint loss component function used to train neural network operational parameters of a sinusoidal neural network to approximate an image warping operation that aligns matching landmarks/keypoints; an inverse constraint loss component function used to ensure consistency and invertibility in the view transition; a loss component function relating to thin-plate-spline (TPS) regularization used to ensure relatively smooth deformations; a linear interpolation loss component function used to ensure that intermediate coordinates predicted by a morphing network to align along a linear trajectory; or a knowledge transfer loss component function used to influence a student or main neural network to produce predictions consistent with predictions produced by a teacher neural network.

14. The method as recited in claim 1, wherein the teacher neural network is at least partly pre-trained before the teacher neural network is jointly trained with the neural implicit morphing network.

15. An apparatus performing the method as recited in claim 1.
